(19) United States
(12) Patent Application Publication
(10) Pub. No.: US 2026/0293997 A1
(43) Pub. Date: Oct. 1, 2026

(54) AEROSOL-GENERATING DEVICE WITH PUFF VOLUME ESTIMATION

(71) Applicant: Philip Morris Products S.A., Neuchatel (CH)

(72) Inventors: Marios GEORGIOU, Lausanne (CH); Karim SAMAHA, Neuchâtel (CH); Alexandre CLIVAZ, Neuchâtel (CH)

(73) Assignee: Philip Morris Products S.A., Neuchatel (CH)

(21) Appl. No.: 19/479,388

(22) PCT Filed: May 2, 2024
(86) PCT No.: PCT/EP2024/062154

§ 371 Date: Oct. 28, 2025

(30) Foreign Application Priority Data
May 2, 2023 (EP) 23171180

(51) Int. Cl. A24F 40/51; A24F 40/48; A24F 40/53; A24F 40/60; A24F 40/65; G01L 15/00; H05B 3/03

(52) U.S. Cl. CPC A24F 40/51; A24F 40/48; A24F 40/53; A24F 40/60; A24F 40/65; G01L 15/00; H05B 3/03

(57) ABSTRACT

An aerosol-generating device is provided, including: a substrate cavity configured to receive an aerosol-forming substrate; an airflow path extending between an inlet and the substrate cavity; a flow restriction located in the airflow path; a pressure detection apparatus configured to detect a pressure in the airflow path at or after the flow restriction, between the flow restriction and the substrate cavity, the pressure detection apparatus including a pressure sensor configured to detect the pressure in the airflow path either at or after the flow restriction; and a controller configured to receive pressure measurement information from the pressure detection apparatus and to determine a puff volume based on pressure measurement information received from the pressure detection apparatus. A method of operating the aerosol-generating device is also provided.

The present disclosure relates to an aerosol-generating device, a method for determining the volume of a puff on an aerosol-generating device, and a method for operating an aerosol-generating device.

Known aerosol-generating systems comprise an aerosol-generating device and an aerosol-forming substrate, wherein the system is configured to generate an aerosol from the aerosol-forming substrate, typically by heating the aerosol-forming substrate.

In some known systems, the aerosol-forming substrate comprises a tobacco rod or a tobacco plug that is arranged in an aerosol-generating article. The aerosol-generating article may resemble a conventional cigarette, having a similar cylindrical stick like configuration.

In some known systems, the aerosol-generating device comprises a power supply, such as a battery, a controller, and a heating element for heating the aerosol-forming substrate. In use, the aerosol-generating article may be inserted into a cavity of the aerosol-generating device, and the heating element either penetrates the aerosol-forming substrate or is arranged around the outside of the aerosol-forming substrate. Power is supplied to the heating element from the power supply to heat the aerosol-forming substrate, and volatile components of the aerosol-forming substrate are vaporised, released and condense to form an aerosol, which is inhalable by a user.

In some known systems, the aerosol-generating device comprises a power supply, such as a battery, a controller, and an inductor coil. The inductor coil may be part of an inductive heating assembly comprising the inductor coil and a susceptor element, wherein the inductor coil generates a varying magnetic field when supplied with a varying current, and the susceptor element is heated when arranged in the varying magnetic field. In these systems, the susceptor element may be arranged either in the aerosol-generating device or in the aerosol-generating article. In use, the aerosol-generating article may be inserted into a cavity of the aerosol-generating device, and power may be supplied to the inductor coil from the power supply to generate a varying magnetic field. The varying magnetic field penetrates the susceptor element, heating the susceptor element, which in turn heats the aerosol-forming substrate, and volatile components of the aerosol-forming substrate are vaporised, released and condense to form an aerosol, which is inhalable by a user.

It has been found to be beneficial in some of these known aerosol-generating systems to control the supply of power to the heating element or the inductor coil based on a determination of when a puff is being taken on the system by a user. Typically, such systems determine when a puff is being taken on the system by a user based on measurements of temperature or resistance of a heating element or a susceptor element.

It would be desirable to provide an aerosol-generating device with improved detection of a puff of a user on the aerosol-generating device. It would also be desirable to provide an aerosol-generating device that is capable of detecting various characteristics of a puff of a user of the aerosol-generating device.

According to the present disclosure, there is provided an aerosol-generating device. The aerosol-generating device may comprise a substrate cavity configured to receive an aerosol-forming substrate. The aerosol-generating device may comprise an airflow path extending between an inlet and the substrate cavity. The aerosol-generating device may comprise pressure detection apparatus configured to detect the pressure in the airflow path.

Advantageously, detecting the pressure in an airflow path of an aerosol-generating device may provide more accurate information on the puff of a user on the aerosol-generating device, such as the duration of the puff and the volume of the puff, compared to detecting the temperature or resistance of a heating element. Improving the accuracy of the information gathered on a puff of a user may enable the aerosol-generating device to maximise the generation of aerosol from the aerosol-forming substrate, improving the experience for a user and improving the efficiency of the aerosol-generating device at generating aerosol. More accurate determination of puff duration may enable the aerosol-generating device to more accurately control the supply of power to the heating element or inductor coil, reducing unnecessary heating of the aerosol-forming substrate. More accurate determination of a puff volume and puff duration may enable the aerosol-generating device to more accurately determine when the aerosol-forming substrate is depleted.

As used herein, “aerosol-generating device” refers to a device that interacts with an aerosol-forming substrate to generate an aerosol. Preferably, the aerosol-generating device is a device that interacts with an aerosol-forming substrate to generate an inhalable aerosol that is directly inhalable into a user's lungs thorough the user's mouth.

As used herein, “aerosol-forming substrate” refers to a substrate capable of releasing volatile compounds that can form an aerosol. Such volatile compounds may be released by heating the aerosol-forming substrate. An aerosol-forming substrate is typically part of an aerosol-generating article.

As used herein, “aerosol-generating article” refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece at a proximal or mouth end of the aerosol-generating article, an aerosol-generating device, or an aerosol-generating system. An aerosol-generating article may be disposable.

As used herein, “aerosol-generating system” refers to the combination of an aerosol-generating device with an aerosol-generating article. In an aerosol-generating system, the aerosol-generating article and the aerosol-generating device cooperate to generate an aerosol.

As used herein, “proximal” refers to a user end, or mouth end of the aerosol-generating device, aerosol-generating article, or aerosol-generating system. The proximal end of a component of an aerosol-generating device, an aerosol-generating article, or an aerosol-generating system is the end of the component closest to the user end, or mouth end of the aerosol-generating device, the aerosol-generating article, or the aerosol-generating system. As used herein, “distal” refers to the end opposite the proximal end.

As used herein, “end” and “side” are used interchangeably to refer to extremities of a feature, such as an aerosol-generating device, a heating assembly, a heating element, or an aerosol-generating article. Preferably, features described herein have two opposing ends and at least one side extending between the two opposing ends. Preferably, features described herein have a length extending in a longitudinal direction between opposing ends, and a width extending in a transverse direction between two opposing sides.

As used herein, “length” refers to the maximum dimension of a feature in a longitudinal direction of the feature.

As used herein, “width” refers to the maximum dimension of a feature in a transverse direction of the feature. The transverse direction is perpendicular to the longitudinal direction.

As used herein, “thickness” and “depth” refer to the maximum dimension of a feature in a direction perpendicular to the longitudinal direction of the feature and perpendicular to the transverse direction of the feature.

The pressure detection apparatus may comprise a pressure sensor. The pressure sensor may comprise any suitable type of pressure sensor. The pressure sensor may be an absolute pressure sensor, configured to determine the absolute pressure at a position in the airflow path. The pressure sensor may be a gauge pressure sensor, configured to detect the relative pressure at a location in the airflow path compared to an ambient pressure adjacent the aerosol-generating device. The pressure sensor may be a differential pressure sensor, configured to detect a difference in pressure between a first position in the airflow path and a second position in the airflow path. The pressure sensor may be a capacitive pressure sensor. The pressure sensor may be a piezoresistive pressure sensor. The pressure sensor may be a strain gauge. Preferably, the pressure sensor is a micro electronic mechanical systems (MEMS) pressure sensor. Advantageously, a MEMS pressure sensor may be small enough to fit into the aerosol-generating device without significantly increasing the size of the aerosol-generating device. An example of a suitable absolute pressure sensor is the MEMS nano pressure sensor LPS22HBTR, manufactured by STMicroelectronics, which has an operating pressure of between about 26 kilopascals (kPa) and about 126 kilopascals (kPa), and dimensions of 2 millimetres by 2 millimetres by 0.76 millimetres.

In some preferred embodiments, the aerosol-generating device comprises a flow restriction located in the airflow path.

The flow restriction may be any suitable flow restriction that causes a pressure drop in the airflow path that is measurable by the pressure sensor when a user takes a puff on the aerosol-generating device.

The flow restriction may comprise a narrow portion of the airflow path through the aerosol-generating device, having a width or a diameter smaller than the width or the diameter of at least one of a portion of the airflow path immediately before the flow restriction and a portion of the airflow path immediately after the flow restriction. The flow restriction may comprise a narrow portion having a width or a diameter smaller than the width or the diameter of the airflow path immediately before the flow restriction. The flow restriction may comprise a narrow portion having a width or a diameter smaller than the width or the diameter of the airflow path immediately after the flow restriction. The flow restriction may comprise a plurality of narrow portions, each having a width or a diameter smaller than the width or the diameter of the airflow path immediately before the flow restriction and the width or the diameter of the airflow path immediately after the flow restriction. Typically, the width or the diameter of the airflow path immediately after the flow restriction is the same as the width or the diameter of the airflow path immediately before the flow restriction.

The flow restriction may comprise a narrow portion of the airflow path through the aerosol-generating device, having a total cross-sectional area smaller than the total cross-sectional area of at least one of a portion of the airflow path immediately before the flow restriction and a portion of the airflow path immediately after the flow restriction. The flow restriction may comprise a narrow portion having a total cross-sectional area than the total cross-sectional area of the airflow path immediately before the flow restriction. The flow restriction may comprise a narrow portion having a total cross-sectional area smaller than the total cross-sectional area of the airflow path immediately after the flow restriction. The flow restriction may comprise a plurality of narrow portions, each having a total cross-sectional area smaller than the total cross-sectional area of the airflow path immediately before the flow restriction and the total cross-sectional area of the airflow path immediately after the flow restriction. Typically, the total cross-sectional area of the airflow path immediately after the flow restriction is the same as the total cross-sectional area of the airflow path immediately before the flow restriction. As used herein, the total cross-sectional area of the airflow path refers to the open area through which air may flow through the airflow path in a cross-section through the airflow path in a direction tangential to the predominant direction of flow of air through the airflow path. Accordingly, where the flow restriction comprises a plurality of inlets. The total cross-sectional area of the airflow path at the inlets refers to the sum of the open area provided by each of the inlets.

In some preferred embodiments, the flow restriction is provided by the inlet of the airflow path. The inlet may comprise a plurality of inlets. For example, the inlet may comprise between one and thirty inlets, or between four and twenty five inlets, or between seven and twenty openings. In some embodiments, the inlet may comprise between fourteen and seventeen inlets. The inlet or plurality of inlets may have any suitable size and shape to provide the desired resistance to draw and pressure drop in the airflow path when a user takes a puff on the aerosol-generating device. For example, in some preferred embodiments, the inlet may comprise between 5 and 25 inlets, more preferably between 14 and 17 inlets, each inlet having a substantially circular cross-sectional shape with a diameter in a range of about 0.3 to 1.2 millimetres, more preferably about 0.5 millimetres. Preferably, the inlet, or the plurality of inlets, is arranged to enable ambient air to be drawn into the aerosol-generating device. The inlet or the plurality of inlets may have a combined total cross-sectional area of less than the cross-sectional area of the airflow path immediately after the inlet or inlets.

In some preferred embodiments, the flow restriction comprises an orifice plate.

In some embodiments, the flow restriction is an element that increases the resistance to draw through the airflow path.

The resistance to draw of the airflow path between the inlet and the pressure sensor, when measured in accordance with the conditions set out in ISO 6565:2015, may be at least about 70 pascals (Pa), at least about 80 pascals (Pa), at least about 90 pascals (Pa), at least about 100 pascals (Pa) (about 10 millimetres of water gauge (mmH₂O)), at least 150 pascals (Pa), at least 200 pascals (Pa), at least 250 pascals (Pa), at least 300 pascals (Pa), or at least about 450 pascals (Pa) (about 45 millimetres of water gauge (mmH₂O). The conditions set out in ISO 6565:2015 comprise an outlet flowrate of 17.5 millilitres per second, an ambient temperature of 22 degrees Celsius, and a relative ambient humidity of 60 percent.

The flow restriction may be configured to cause a pressure drop of at least 70 pascals (Pa), at least 80 pascals (Pa), at least 90 pascals (Pa), at least 100 pascals (Pa) (10 millimetres of water gauge), at least 150 pascals (Pa), at least 200 pascals (Pa), at least 250 pascals (Pa), or at least 300 pascals (Pa) during a typical puff of a user.

The aerosol-generating device may comprise pressure detection apparatus configured to detect the pressure in the airflow path at or after the flow restriction.

Advantageously, detecting the pressure at or after a flow restriction of the airflow path may provide more accurate information on the puff of a user on the aerosol-generating device. Detecting the pressure at or after the flow restriction may enable detection of the pressure drop caused by the flow restriction, which may be used to determine the volume of air drawn through the flow restriction.

According to some preferred embodiments, there is provided an aerosol-generating device comprising: a substrate cavity configured to receive an aerosol-forming substrate; an airflow path extending between an inlet and the substrate cavity; a flow restriction located in the airflow path; and pressure detection apparatus configured to detect the pressure in the airflow path at or after the flow restriction.

In some preferred embodiments, the pressure detection apparatus is configured to detect a differential pressure in the airflow path.

In some preferred embodiments, the pressure detection apparatus is configured to detect the pressure in the airflow path before the flow restriction, between the inlet and the flow restriction, and the pressure at or after the flow restriction. In some of these embodiments, the pressure detection apparatus comprises a first pressure sensor configured to detect the pressure in the airflow path before the flow restriction, and a second pressure sensor configured to detect the pressure in the airflow path at or after the flow restriction. In some of these embodiments, the pressure detection apparatus comprises a differential pressure sensor configured to detect the difference between the pressure before the flow restriction and the pressure at or after the flow restriction.

In some preferred embodiments, the pressure detection apparatus is configured to detect the pressure in the airflow path at the flow restriction and the pressure after the flow restriction, between the flow restriction and the substrate cavity. In some of these embodiments, the pressure detection apparatus comprises a first pressure sensor configured to detect the pressure in the airflow path at the flow restriction, and a second pressure sensor configured to detect the pressure in the airflow path after the flow restriction. In some of these embodiments, the pressure detection apparatus comprises a differential pressure sensor configured to detect the difference between the pressure at the flow restriction and the pressure after the flow restriction.

Advantageously, a differential pressure measurement taken between two locations in the airflow path may not affected by the local environmental conditions, such as altitude and humidity. Accordingly, where a differential pressure measurement is taken, the pressure detection apparatus may not require re-calibration for use in different environments, such as at different altitudes.

Where the pressure is measured at the flow restriction, the pressure may be measured in the flow restriction. In these embodiments, the flow restriction has a longitudinal extent. In these embodiments, the flow restriction may be elongate.

Where the pressure is measured before the flow restriction, or upstream of the flow restriction, the pressure may be measured at any suitable location before the flow restriction. For example, the pressure may be measured immediately before the flow restriction. The pressure before the flow restriction may be measured at a distance away from the flow restriction, in the downstream direction. The airflow path immediately before the flow restriction, or upstream of the flow restriction, may have a width. The pressure before the flow restriction may be measured at a distance away from the flow restriction of the width of the airflow path immediately before the flow restriction. The pressure before the flow restriction may be measured at a distance away from the flow restriction of a multiple of the width of the airflow path immediately before the flow restriction. The pressure before the flow restriction may be measured at a distance away from the flow restriction of a fraction of the width of the airflow path immediately before the flow restriction. The pressure before the flow restriction may be measured at a distance of 1 millimetre, 2 millimetres, 3 millimetres, 4 millimetres, 5 millimetres, 6 millimetres, 7 millimetres, 8 millimetres, 9 millimetres or 10 millimetres before the flow restriction. The pressure before the flow restriction may be measured at a distance of 25.4 millimetres (1 inch) before the flow restriction.

Where the pressure is measured after the flow restriction, or downstream of the flow restriction, the pressure may be measured at any suitable location after the flow restriction. For example, in some preferred embodiments, the pressure is measured immediately after the flow restriction. The pressure after the flow restriction may be measured at a distance away from the flow restriction, in the downstream direction. The airflow path immediately after the flow restriction, or downstream of the flow restriction, may have a width. The pressure after the flow restriction may be measured at a distance away from the flow restriction of the width of the airflow path immediately after flow restriction. The pressure after the flow restriction may be measured at a distance away from the flow restriction of a multiple of the width of the airflow path immediately after the flow restriction. The pressure after the flow restriction may be measured at a distance away from the flow restriction of a fraction of the width of the airflow path immediately after the flow restriction. The pressure after the flow restriction may be measured at a distance of 1 millimetre, 2 millimetres, 3 millimetres, 4 millimetres, 5 millimetres, 6 millimetres, 7 millimetres, 8 millimetres, 9 millimetres or 10 millimetres after the flow restriction. The pressure after the flow restriction may be measured at a distance of 25.4 millimetres (1 inch) after the flow restriction.

In some embodiments, the pressure before the flow restriction may be measured at a distance away from the flow restriction of the width of the airflow path immediately before the flow restriction, and the pressure after the flow restriction may be measured at a distance away from the flow restriction of half the width of the airflow path immediately after flow restriction.

In some embodiments, the pressure after the flow restriction may be measured at a distance away from the flow restriction of two and a half widths of the airflow path immediately before the flow restriction, and the pressure after the flow restriction may be measured at a distance away from the flow restriction of eight widths of the airflow path immediately after the flow restriction.

In some embodiments, the pressure before the flow restriction may be measured at a distance away from the flow restriction of the width of the airflow path immediately before the flow restriction, and the pressure after the flow restriction may be measured at a distance away from the flow restriction of between 0.3 and 0.9 widths of the airflow path immediately after flow restriction. Measuring the pressure after the flow restriction at a distance away from the flow restriction of between 0.3 and 0.9 widths of the airflow path immediately after the flow restriction may measure the pressure in the plane of minimum fluid pressure during a puff on the aerosol-generating device.

In some embodiments, the aerosol-generating device may comprise two flow restrictions, a first flow restriction as described above, and a second flow restriction after the first flow restriction or downstream of the first flow restriction. The pressure detection apparatus may be arranged between the inlet and the second flow restriction. Accordingly, the pressure detection apparatus may be arranged to detect the pressure drop in the airflow path resulting from the first flow restriction, rather than the second flow restriction. The second flow restriction may help to prevent backflow of vapour or aerosol generated in the substrate cavity from entering the airflow path between puffs on the aerosol-generating device. As such, the second flow restriction may help to keep the pressure detection apparatus clean by keeping the pressure detection apparatus away from generated vapour and aerosol.

The aerosol-generating device may further comprise a controller. The controller may be configured to receive pressure measurement information from the pressure detection apparatus. The pressure measurement information may comprise any information obtainable from a pressure detector. The pressure measurement information may comprise at least one of: the pressure before the flow restriction; the pressure at the flow restriction; the pressure after the flow restriction; the difference between the pressure before the flow restriction and the pressure at or after the flow restriction; the difference between the pressure at the flow restriction and the pressure after the flow restriction; and a puff duration, wherein the puff duration is the duration of a puff on the aerosol-generating device.

The controller may be configured to receive pressure measurement information from the pressure detection apparatus at regular intervals. The controller may be configured to regularly receive pressure measurement information from the pressure detection apparatus. The controller may be configured to continuously receive pressure measurement information from the pressure detection apparatus. The controller may be configured to receive pressure measurement information at any suitable sampling rate. For example, the controller may be configured to receive pressure measurement information at a sampling rate of at least 50 Hertz, at least 60 Hertz, at least 65 Hertz. In some preferred embodiments, the controller is configured to receive pressure measurement information at a sampling rate of about 75 Hertz.

The controller may be configured to determine an average pressure from pressure measurement information received from the pressure detection apparatus over time. The average pressure may be a moving average. In other words, the average pressure may be updated for each subsequent measurement of pressure. The moving average pressure may be a mean pressure, a median pressure, or a mode pressure. The moving average pressure may be determined from a plurality of pressure measurements received from the pressure detection apparatus. The moving average pressure may be determined from a plurality of consecutive pressure measurements received from the pressure detection apparatus. The moving average pressure may be determined from any suitable number of pressure measurements. For example, the moving average may be determined from at least two, three, four, five, six, seven, eight, nine or ten pressure measurements. The moving average pressure may be determined from between 2 and 100 pressure measurements, between 2 and 75 pressure measurements, or between 2 and 40 pressure measurements.

Determining a moving average pressure from a plurality of pressure measurements taken over time may provide the controller with a baseline pressure against which subsequent pressure measurements may be compared. Comparing subsequent pressure measurements to the determined average pressure measurement may enable the controller to determine larger than expected changes in the measured pressure. Larger than expected changes in pressure in the airflow path may indicate that a user is taking a puff on the aerosol-generating device.

The controller may be configured to determine when a user is taking a puff on the aerosol-generating device based on pressure measurement information received from the pressure detection apparatus. The controller may be configured to detect a puff on the aerosol-generating device based on pressure measurement information received from the pressure detection apparatus. The controller may be configured to determine when a user is taking a puff on the aerosol-generating device based on a comparison of pressure measurement information received from the pressure detection apparatus to a threshold value.

In some preferred embodiments, the controller may be configured to determine a moving average pressure from pressure measurement information received from the pressure detection apparatus over time, compare a subsequent pressure measurement to the determined moving average pressure, and determine when a user is taking a puff on the aerosol-generating device based on the comparison. When a puff is detected, the moving average may be held constant, or not updated, until it is determined that the user has stopped taking a puff on the aerosol-generating device. Holding the moving average pressure constant while a user is taking a puff on the aerosol-generating device may enable the moving average pressure to be used as a baseline pressure against which pressure measurements taking during a puff may be compared. Holding the moving average pressure constant during a puff may enable the end of a puff to be determined.

Advantageously, determining when a user is taking a puff on the aerosol-generating device based on a moving average pressure, and comparing subsequent pressure measurements to the moving average pressure, may reduce the likelihood of false determinations of puffs resulting from changes in atmospheric pressure, such as changes in altitude, compared to comparisons of pressure measurements with static thresholds. This is because the determined moving average is able to change with gradual changes in external pressure, In particular, comparing pressure measurements to a determined moving average pressure, rather than a static threshold value, is advantageous when a single pressure sensor is provided, sensing the absolute pressure in the airflow path. Where a gauge pressure sensor, differential pressure sensor, or two or more pressure sensors are provided, and a differential pressure is measured or determined, there is less benefit to comparing differential pressure measurements or pressure differences to a determined moving average, rather than a static threshold value. This is because differential pressure measurements or pressure differences are less affected by changes is external or atmospheric pressure than individual, absolute pressure measurements.

The controller may be configured to determine the end of a puff on the aerosol-generating device based on pressure measurement information received from the pressure detection apparatus. The controller may be configured to determine when a user stops taking a puff on the aerosol-generating device based on pressure measurement information received from the pressure detection apparatus. The controller may be configured to determine when a user stops taking a puff on the aerosol-generating device based on a comparison of pressure measurement information received from the pressure detection apparatus to a threshold value. The controller may be configured to determine a moving average pressure from pressure measurement information received from the pressure detection apparatus over time, compare a subsequent pressure measurement to the determined moving average pressure, determine when a user is taking a puff on the aerosol-generating device based on the comparison, and determine when a user stops taking a puff on the aerosol-generating device based on a comparison of a further subsequent pressure measurement to the previously determined moving average. In other words, the determined moving average pressure used in the comparison with the subsequent pressure measurement when the puff was detected may be stored by the controller and used as a baseline or a threshold against which further subsequent pressure measurements are compared to determine when the user stops taking a puff on the aerosol-generating device.

The controller may be configured to determine a puff duration based on pressure measurement information received from the pressure detection apparatus. The controller may be configured to determine a puff duration based on the difference in time between when it is first determined that a user is taking a puff on the aerosol-generating device and when it is next determined that the user has stopped taking a puff on the aerosol-generating device.

A typical puff duration may range from between about 1 second and about eight seconds, and more typically between about 3 seconds and about six seconds.

The controller may be configured to determine a puff volume based on pressure measurement information received from the pressure detection apparatus. Advantageously, it has been found that a puff volume determined from measurements of pressure may be more accurate than a puff volume determined from a measurement of temperature or resistance of a heater or susceptor element.

In some preferred embodiments, there is provided an aerosol-generating device comprising: a substrate cavity configured to receive an aerosol-forming substrate; an airflow path extending between an inlet and the substrate cavity; a flow restriction located in the airflow path; pressure detection apparatus configured to detect the pressure in the airflow path; and a controller, the controller being configured to receive pressure measurement information from the pressure detection apparatus, and determine a puff volume based on pressure measurement information received from the pressure detection apparatus.

In some preferred embodiments, there is provided an aerosol-generating device comprising: a substrate cavity configured to receive an aerosol-forming substrate; an airflow path extending between an inlet and the substrate cavity; a flow restriction located in the airflow path; a pressure sensor configured to detect a pressure in the airflow path at or after the flow restriction, between the flow restriction and the substrate cavity; and a controller configured to determine a volumetric quantity of the air passing through the airflow path based on a plurality of measurements from the pressure sensor.

As used herein, “puff volume” refers to the volume of air drawn through the aerosol-generating device during a puff on the aerosol-generating device taken by a user. Accordingly, the term “puff volume” used herein does not refer to the total system puff volume inhaled by a user when taking a puff on the aerosol-generating system. The volume of air drawn through the aerosol-generating device during a puff may differ from the total system volume inhaled by a user because the system may include additional points of ventilation that increase the total puff volume inhaled by a user compared to the volume of air drawn through the aerosol-generating device. For example, where the aerosol-generating device is used in combination with an aerosol-generating article to form an aerosol-generating system, the aerosol-generating article may comprise ventilation holes to promote generation of aerosol in the aerosol-generating article, and the additional airflow into the aerosol-generating article may not flow through the aerosol-generating device.

As used herein, “volumetric quantity” refers to a quantity related to the volume of air drawn through the aerosol-generating device during a puff.

A typical puff on an aerosol-generating device may have a puff volume of between about 15 millilitres and about 60 millilitres.

Where the pressure detection apparatus measures the pressure before a flow restriction and the pressure at or after the flow restriction, the controller may be configured to determine a puff volume based on the difference between the pressure before the flow restriction and the pressure at the flow restriction. Where the pressure detection apparatus is configured to detect the pressure in the airflow path at the flow restriction and the pressure after the flow restriction, the controller may be configured to determine a puff volume based on the difference between the pressure at the flow restriction and the pressure after the flow restriction.

Advantageously, a puff volume determined based on a differential pressure measurement may be less sensitive to local environmental conditions and to use conditions, such as ambient temperature, state of the aerosol-forming substrate, and the device's geometry or heating technology, than puff volumes determined using absolute pressure measurements.

The controller may be configured to determine a puff volume based on pressure measurement information received from the pressure detection apparatus.

The controller may be configured to determine a puff volume based on pressure measurement information received from a single pressure sensor. One way to determine a puff volume using a single pressure sensor, sensing the absolute pressure in the airflow path at or after the flow restriction is as follows. The pressure drop, ΔP, may be determined by (equation 1):

$$Δ P = \overline{P} - P$$

where P̅ is the moving average pressure determined from a plurality of consecutive pressure measurements, and P is a subsequent pressure measurement taken after the last pressure measurement used to calculate the moving average pressure.

The volumetric flow rate, Q, may then be determined by (equation 2):

$$Q = a \times Δ P$$

where a is a multiplier with the units millilitre per second millibar (ml/s·mbar). It is possible to determine the multiplier a by calibration of the pressure sensor in the aerosol-generating device.

The puff volume may then be determined by integrating the volumetric flow rate over the determined duration of the user's puff, as follows (equation 3):

$$V = {\int }_{t 0}^{t 1} ( Q + b ) d t$$

where t₀ is the time at the start of a puff, t₁ is the time at the end of a puff, and b is a flow duration bias, with the units millilitre per second (ml/s). It is also possible to determine b by calibration of the puff sensor in the aerosol-generating device.

The controller may be configured to determine a puff volume based on a differential pressure measurement, or a difference between two pressure measurements.

One way to determine a puff volume using a differential pressure measurement, or the difference between two pressure measurements taken either before and after a flow restriction, before and at a flow restriction, or at and after a flow restriction is by using Bernoulli's equation.

For example, taking pressure measurements at a first section of the airflow path immediately before the flow restriction and pressure measurements at a second section of the airflow path at the downstream end of the flow restriction or just after the flow restriction, a puff volume may be determined as follows.

Assuming the section of the airflow path immediately before the flow restriction has a circular cross-section with radius R₁ and the flow restriction is a narrow portion of the airflow path having a circular cross-section with radius R₂, Bernoulli's equation is (Equation 4):

$${P}_{1} + \frac{1}{2} ρ {v}_{1}^{2} = {P}_{2} + \frac{1}{2} ρ {v}_{2}^{2}$$

where P₁ is the pressure before the flow restriction, P₂ is the pressure at the downstream end of the flow restriction, v₁ is the velocity of air before the flow restriction, v₂ is the velocity of air at the downstream end of the flow restriction, and ρ is the density of air in the airflow path. It is assumed that the density of the air in the airflow path is a constant throughout the airflow path. This equation also makes the assumption that there is no change in height between the portion of the airflow path before the flow restriction and the downstream end of the flow restriction.

Equation 4 can be rewritten as (Equation 5):

$${P}_{2} - {P}_{1} = \frac{1}{2} ρ {v}_{1}^{2} - \frac{1}{2} ρ {v}_{2}^{2} = \frac{ρ}{2} ( {v}_{1}^{2} - {v}_{2}^{2} )$$

The mass flow rate (m) through a circular cross-section pipe is given by (Equation 6):

$$\dot{m} = \frac{d m}{d t} = v A ρ = v π {R}^{2} ρ$$

where A is the cross-sectional area of the portion of the airflow path and R is the radius of the portion of airflow path. Assuming the mass flow rate (m) is the same before the flow restriction and at the downstream end of the flow restriction, the velocities v₁ and v₂ before the flow restriction and at the downstream end of the flow restriction can be written as (Equation 7):

$${v}_{1} = \frac{\dot{m}}{{A}_{1} ρ} = \frac{\dot{m}}{π {R}_{1}^{2} ρ} and {v}_{2} = \frac{\dot{m}}{{A}_{2} ρ} = \frac{\dot{m}}{π {R}_{2}^{2} ρ}$$

Substituting the velocities of Equation 7 into Equation 5 gives (Equation 8):

$${P}_{2} - {P}_{1} = \frac{ρ}{2} ( {( \frac{\dot{m}}{{A}_{1} ρ} )}^{2} - {( \frac{\dot{m}}{{A}_{2} ρ} )}^{2} ) = \frac{ρ}{2} \frac{{\dot{m}}^{2}}{{ρ}^{2}} ( {( \frac{1}{{A}_{1}^{2}} )}^{2} - {( \frac{1}{{A}_{2}^{2}} )}^{2} ) = \frac{{\dot{m}}^{2}}{{ρ}^{2}} \frac{ρ}{2 {π}^{2}} ( \frac{1}{{R}_{1}^{4}} - \frac{1}{{R}_{2}^{4}} )$$

which may be rewritten as (Equation 9):

$$\frac{{\dot{m}}^{2}}{{ρ}^{2}} = \frac{2 {π}^{2}}{ρ} ( \frac{1}{{R}_{1}^{4}} - \frac{1}{{R}_{2}^{4}} ) ( {P}_{2} - {P}_{1} )$$

The volumetric flow rate (Q) is given by (Equation 10):

$$Q = \frac{\dot{m}}{ρ}$$

Substituting Equation 3 into the volumetric flow rate equation gives (Equation 11):

$$Q = \frac{\dot{m}}{ρ} = \sqrt{\frac{2 {π}^{2}}{ρ} \frac{1}{( \frac{1}{{R}_{1}^{4}} - \frac{1}{{R}_{2}^{4}} )} ( {P}_{2} - {P}_{1} )}$$

Integrating the volumetric flow rate (Q) with respect to time for the duration of the puff gives the total volume of air in the puff (Equation 12):

$$V = {\int }_{t 0}^{t 1} \sqrt{\frac{2 {π}^{2}}{ρ} \frac{1}{( \frac{1}{{R}_{1}^{4}} - \frac{1}{{R}_{2}^{4}} )} ( {P}_{2} - {P}_{1} )}$$

Assuming the density of air (ρ) is a constant throughout the airflow path, which is known, and the radius of the airflow path before the flow restriction (R₁) and the radius of the airflow path at the downstream end of the flow restriction (R₂) are known, the volume (V) of a puff between times t₀ and t₁ may be determined. Again, where t₀ is the time at the start of a puff, and t₁ is the time at the end of a puff.

According to the present disclosure, there is provided a method of determining the volume of a puff on an aerosol-generating device, the method comprising:
measuring the pressure at or after a flow restriction of an airflow path of the aerosol-generating device;
determining an average pressure from a plurality of the pressure measurements;
determining the difference between a subsequent pressure measurement and the average pressure;
detecting a puff on the aerosol-generating device by determining whether the difference between the subsequent pressure measurement and the average pressure is indicative of a pressure drop corresponding to a puff on the aerosol-generating device by a user;
when a puff is detected, determining the difference between subsequent pressure measurements during the puff and the average pressure;
determining the duration of the puff from the differences between the subsequent pressure measurements and the average pressure;
summing, over the duration of the puff, the differences between the pressure measurements during the puff and the average pressure; and
determining the volume of the puff based on the summed differences between the pressure measurements during the puff and the average pressure over the determined puff duration.

The determination of whether the difference between the subsequent pressure measurement and the average pressure is indicative of a pressure drop corresponding to a puff on the aerosol-generating device by a user may comprise determining when the difference exceeds a threshold value. For example, the controller may be configured to determine that a user is taking a puff on the aerosol-generating device where a pressure measurement differs from the average pressure by more than 0.2 millibars, 0.4 millibars, 0.6 millibars, 0.8 millibars, 1 millibar, 1.5 millibars, 2 millibars, 2.5 millibars or 5 millibars. The controller may be configured to determine that a user is taking a puff on the aerosol-generating device where a pressure measurement differs from the determined average pressure by more than 10 percent, 15 percent, 20 percent, 25 percent, 30 percent, 35 percent or 40 percent of the determined average pressure.

As described above, the average pressure determination may be a moving average pressure determination that is updated with each new pressure measurement until a puff is detected. The average pressure may be determined from any suitable number of pressure measurements, as described above, such as between 2 and 40 pressure measurements.

According to the present disclosure, there is provided a method of determining the volume of a puff on an aerosol-generating device, the method comprising:
measuring the pressure before a flow restriction of an airflow path of the aerosol-generating device during a puff on the aerosol-generating device;
measuring the pressure at or after a flow restriction of an airflow path of the aerosol-generating device during a puff on the aerosol-generating device;
determining the difference between pressure measurements before the flow restriction and pressure measurements at or after the flow restriction during the puff;
determining the duration of the puff from the differences between the pressure measurements before the flow restriction and the pressure measurements at or after the flow restriction during the puff;
summing, over the duration of the puff, the differences between the pressure measurements before the flow restriction and the pressure measurements at or after the flow restriction; and
determining the volume of the puff based on the summed differences between the pressure measurements before the flow restriction and the pressure measurements at or after the flow restriction over the puff duration.

According to the present disclosure, there is provided a method of determining the volume of a puff on an aerosol-generating device, the method comprising:
measuring the pressure at a flow restriction of an airflow path of the aerosol-generating device during a puff on the aerosol-generating device;
measuring the pressure after the flow restriction of an airflow path of the aerosol-generating device during a puff on the aerosol-generating device;
determining the difference between pressure measurements at the flow restriction and pressure measurements after the flow restriction during the puff;
determining the duration of the puff from the differences between the pressure measurements at flow restriction and the pressure measurements after the flow restriction during the puff;
summing, over the duration of the puff, the differences between the pressure measurements at the flow restriction and the pressure measurements after the flow restriction; and
determining the volume of the puff based on the summed differences between the pressure measurements at the flow restriction and the pressure measurements after the flow restriction over the puff duration.

The controller of the aerosol-generating deice may be configured to perform any of the above described methods of determining the volume of a puff on the aerosol-generating device.

Preferably, the aerosol-generating device comprises an aerosol generator configured to generate an aerosol from an aerosol-forming substrate received in the substrate cavity.

In some embodiments, the controller is configured to control a supply of power to the aerosol generator based on the received pressure measurement information. In some embodiments, the controller is configured to control a supply of power to the aerosol generator based on the determined puff volume. In some embodiments, the controller is configured to control a supply of power to the aerosol generator based on the determined puff duration. In some preferred embodiments, the controller is configured to control a supply of power to the aerosol generator based on the determined puff volume and the determined puff duration.

In some embodiments, the aerosol-generator comprises a resistive heating element. The resistive heating element may be located in or around the substrate cavity. The resistive heating element may be arranged to heat an outer surface of an aerosol-forming substrate received in the substrate cavity. The resistive heating element may be arranged to pierce an aerosol-forming substrate received in the substrate cavity and heat the aerosol-forming substrate from the inside.

The heating element may be formed from any suitable material.

The heating element may be formed from an electrically conductive material.

As used herein, “electrically conductive” refers to a material having a volume resistivity at 20 degrees Celsius (° C.) of less than about 1×10⁻⁵ ohm-metres (Ωm), typically between about 1×10⁻⁵ ohm-metres (Ωm) and about 1×10⁻⁹ ohm-metres (Ωm).

The heating element may be formed from a thermally conductive material.

As used herein, “thermally conductive” refers to a material having a bulk thermal conductivity of at least about 10 Watts per metre Kelvin (mW/(m K)) at 23 degrees Celsius (C) and a relative humidity of 50 percent as measured using the modified transient plane source (MTPS) method.

The heating element may be formed from at least one of: graphite, molybdenum, silicon carbide, a metal, stainless steel, niobium, aluminium, nickel, titanium, and composites of metallic materials.

In some embodiments, the aerosol generator comprises an inductor coil. The inductor coil may generate a varying magnetic field when a varying current is supplied to the inductor coil. The inductor coil may be configured to generate a varying magnetic field in the substrate cavity. The inductor coil may be located in or around the substrate cavity. The inductor coil may circumscribe the substrate cavity.

As used herein, “varying current” refers to a current that varies with time. An inductor coil generates a varying magnetic field when a varying electric current is supplied to the inductor coil. The term “varying current” is intended to include alternating currents. Where the varying current is an alternating current, the alternating current generates an alternating magnetic field.

The varying current may be an alternating current. As used herein, “alternating current” refers to a current that periodically reverses direction. The alternating current may have any suitable frequency. Suitable frequencies for the alternating current may be between 100 kilohertz (kHz) and 30 megahertz (MHz). Where the at least one inductor coil is a tubular inductor coil, the alternating current may have a frequency of between 500 kilohertz (kHz) and 30 megahertz (MHz). Where the at least one inductor coil is a flat coil, the alternating current may have a frequency of be-tween 100 kilohertz (kHz), and 1 megahertz (MHz).

The inductor coil may have any suitable form. The inductor coil may be a tubular inductor coil. The inductor coil may be a planar inductor coil. The inductor coil may be a flat inductor coil. Preferably, the inductor coil is a tubular coil that circumscribes the substrate cavity.

The inductor coil may have any suitable number of turns.

The inductor coil may be formed from any suitable material. The inductor coil may be formed from at least one of: silver, gold, aluminium, brass, zinc, iron, nickel, and alloys of thereof, and electrically conductive ceramics, such as yttrium-doped zirconia, indium tin oxide, and yttrium doped titanate.

In some embodiments in which the aerosol generator comprises an inductor coil, the aerosol generator further comprises a susceptor element. The inductor coil may be configured to generate a varying magnetic field that penetrates the susceptor element. The susceptor element may be arranged to be penetrated by the varying magnetic field generated by the inductor coil when the varying current is supplied to the inductor coil.

As used herein, “susceptor element” refers to an element that is heatable by penetration with a varying magnetic field. A susceptor element is typically heatable by at least one of Joule heating through induction of eddy currents in the susceptor element, and hysteresis losses.

The susceptor element may be located in or around the substrate cavity. The susceptor element may be is configured to heat an outer surface of an aerosol-forming substrate received in the substrate cavity.

In some embodiments, the susceptor element is located in the substrate cavity and is configured to pierce an aerosol-forming substrate received in the substrate cavity and heat the aerosol-forming substrate from the inside.

The susceptor element may be formed from any suitable material. Preferably, the susceptor element comprises a magnetic material that is heatable by penetration with a varying magnetic field. The magnetic material may be a ferromagnetic material, such as ferrite, ferritic iron, a ferromagnetic alloy, a ferromagnetic steel, or a ferromagnetic stainless steel such as SAE 400 series stainless steels, SAE type 409, 410, 420 or 430 stainless steels.

As used herein, “magnetic material” refers to a material which is able to interact with a magnetic field, including both paramagnetic and ferromagnetic materials.

In some preferred embodiments, the susceptor element comprises at least about 5 percent, or at least about 20 percent, or at least about 50 percent, or at least about 90 percent of ferromagnetic or paramagnetic materials on a dry weight basis.

The susceptor element shape may be different to the inductor coil shape. Preferably, the susceptor element shape is substantially the same as the inductor coil shape.

The inductor coil size may be different to the inductor coil size. Preferably, the susceptor element size is substantially the same as the inductor coil size.

The aerosol-generating device comprises a controller. The controller may be configured to control a supply of power to the aerosol-generator. The controller may comprise a microprocessor, which may be a programmable microprocessor, a microcontroller, or an application specific integrated chip (ASIC) or other electronic circuitry capable of providing control. The control circuitry may comprise further electronic components. The control circuitry may be configured to regulate a supply of current to the inductor coil. Current may be supplied to the inductor coil continuously following activation of the aerosol-generating device or may be supplied intermittently, such as on a puff by puff basis. The control circuitry may advantageously comprise DC/AC inverter, which may comprise a Class-D or Class-E power amplifier.

The aerosol-generating device may further comprise a power supply. The power supply may be configured to supply power to the aerosol generator. The controller may be configured to control the supply of power from the power supply to the aerosol generator.

The power supply may be a DC power supply. The power supply may comprise at least one of a battery and a capacitor. In one embodiment, the power supply is a DC power supply having a DC supply voltage in the range of about 2.5 Volts to about 4.5 Volts and a DC supply current in the range of about 1 Amp to about 10 Amps (corresponding to a DC power supply in the range of about 2.5 Watts to about 45 Watts).

The power supply may be configured to operate at high frequency. As used herein, the term “high frequency oscillating current” means an oscillating current having a frequency of between about 500 kilohertz and about 30 megahertz. The high frequency oscillating current may have a frequency of from about 1 megahertz to about 30 megahertz, preferably from about 1 megahertz to about 10 megahertz and more preferably from about 5 megahertz to about 8 megahertz.

Where the aerosol-generating device comprises an inductor coil, the power supply and the controller may be configured to supply an alternating current to the inductor coil.

Where the controller is configured to control the supply of power to the aerosol generator, the controller may be configured to control the supply of power to the aerosol generator in any suitable way. Preferably, the controller is configured to control the supply of power to the aerosol generator in pulses. Where the controller is configured to control the supply of power to the aerosol generator in pulses, the controller may be configured to control the supply of power to the aerosol generator by pulse width modulation.

The controller may be configured to control the supply of power to the aerosol-generating based on pressure measurement information received from the pressure detection apparatus. The controller may be configured to control the supply of power to the aerosol generator based on at least one of the determined puff volume and the determined puff duration.

Advantageously, accurate puff volume determination may enable a user's usage of the aerosol-generating device or consumption pattern of an aerosol-forming substrate to be accurately determined. Accurate determination of a user's usage of the aerosol-generating device or consumption pattern of an aerosol-forming substrate many enable the aerosol generating experience to be personalised to a user. For example, the power supplied to the aerosol generator during a puff on the aerosol-generating device may be increased and supplied for a longer period of time for a user that takes long and large volume puffs on the aerosol-generating device compared to a user that takes shorter and smaller volume puffs. This may improve the experience for the user and potentially reduce wastage of aerosol-forming substrate.

The controller may be configured to compare the determined puff volume to a threshold value. Based on the comparison, the controller may be configured to increase the supply of power to the aerosol generator if the determined puff volume is above the threshold value. Based on the comparison, the controller may be configured to decrease the supply of power to the aerosol generator if the determined puff volume is below the threshold value. Based on the comparison, the controller may be configured to increase the duration of the supply of power to the aerosol generator if the determined puff volume is above the threshold value. Based on the comparison, the controller may be configured to decrease the duration of the supply of power to the aerosol generator if the determined puff volume is below the threshold value.

Determining at least one of the puff volume and the puff duration, and particularly determining both the puff volume and the puff duration, may enable the controller to determine how quickly the aerosol-forming substrate in the substrate cavity is being depleted. As such, determining at least one of the puff volume and the puff duration may enable the controller to determine how many puffs a user can take before the aerosol-forming substrate in the substrate cavity is fully consumed or how long the aerosol generation can continue before the aerosol-forming substrate in the substrate cavity is fully consumed.

The controller may be configured to determine a maximum number of puffs remaining, which corresponds to the maximum number of puffs a user is able take on the aerosol-generating device before the aerosol-generating substrate received in the substrate cavity is depleted. The controller may be configured to use pressure information from the pressure detection apparatus to determine the maximum number of puffs remaining. The controller may be configured to determine the maximum number of puffs remaining based on the determined puff volume. The controller may be configured to determine the maximum number of puffs remaining based on the determined puff duration. The controller may be configured to determine the maximum number of puffs remaining based on the determined puff volume and the determined puff duration. The controller may be configured to determine the maximum number of puffs remaining based on an average of determined puff volumes for a plurality of puffs. The average puff volume may be one of the mean, median and mode volume. The average puff volume may be determined for a plurality of consecutive puffs. Advantageously, using an average puff volume to determine the maximum number of puffs remaining may provide a more reliable determination of the maximum number of puffs remaining.

In some embodiments, the controller is configured to prevent the supply of power to the aerosol generator once the determined maximum number of puffs remaining has been reached. In some embodiments, the controller is configured to prevent the supply of power to the aerosol generator once the determined maximum number of puffs remaining reaches zero. Advantageously, this may prevent the aerosol-generating device from generating less than optimal aerosol when the aerosol-forming substrate in the substrate cavity has been consumed.

The controller may be configured to determine a maximum duration of time remaining for aerosol generation, which corresponds to a maximum duration of time power is able to be supplied to the aerosol generator before the aerosol-generating substrate received in the substrate cavity is depleted. The controller may be configured to use pressure information from the pressure detection apparatus to determine the maximum duration of time remaining for aerosol generation. The controller may be configured to determine the maximum duration of time remaining for aerosol generation based on the determined puff volume. The controller may be configured to determine the maximum duration of time remaining for aerosol generation based on the determined puff duration. The controller may be configured to determine the maximum duration of time remaining for aerosol generation based on the determined puff volume and the determined puff duration. The controller may be configured to the maximum duration of time remaining for aerosol generation based on an average of determined puff durations for a plurality of puffs. The average puff duration may be one of the mean, median and mode volume. The average puff duration may be determined for a plurality of consecutive puffs. Advantageously, using an average puff duration to determine the maximum duration of time remaining for aerosol generation may provide a more reliable determination of the maximum duration of time remaining for aerosol generation.

In some embodiments, the controller is configured to prevent the supply of power to the aerosol generator once the determined maximum duration of time remaining for aerosol generation has been reached. In some embodiments, the controller is configured to prevent the supply of power to the aerosol generator once the determined maximum duration of time remaining for aerosol generation reaches zero. Advantageously, this may prevent the aerosol-generating device from generating less than optimal aerosol when the aerosol-forming substrate in the substrate cavity has been consumed.

In some embodiments, the controller is configured to determine usage information or receive usage information from an external device, based on pressure measurement information from the pressure detection apparatus. As used herein, “usage information” refers to information regarding a user's puffing habits on the aerosol-generating device, which is based on the pressure measurement information from the pressure detection apparatus.

The usage information may comprise at least one of:
a maximum number of puffs remaining, which corresponds to a maximum number of puffs a user a user is able take on the aerosol-generating device before the aerosol-generating substrate received in the substrate cavity is depleted;
a maximum duration of time remaining for aerosol generation, which corresponds to a maximum duration of time power is able to be supplied to the aerosol generator before the aerosol-generating substrate received in the substrate cavity is depleted;
a puff count, wherein the puff count is the number of puffs a user has taken on the aerosol-generating device for an aerosol-forming substrate received in the substrate cavity; and
a depletion level of the aerosol-forming substrate, the depletion level corresponding to a fraction or percentage of the aerosol-forming substrate that has not been consumed or depleted during use.

In some embodiments, the controller is configured to determine the usage information based pressure measurement information received from the pressure detection apparatus. The controller may be configured to determine the usage information based on at least one of the determined puff volume and the determined puff duration.

The usage information may be determined based on an average of determined puff volumes for a plurality of puffs. The usage information may be determined based on an average of determined puff durations for a plurality of puffs.

In some embodiments, the aerosol-generating device may comprises a receiver. The receiver may be configured to receive a usage signal from an external device. The usage signal comprises usage information.

Where the aerosol-generating device comprises an aerosol generator, the controller may be configured to control a supply of power to the aerosol generator based on the usage information.

In some preferred embodiments, the aerosol-generating device further comprises an indicator. The indicator may be coupled to the controller. The controller may be configured to indicate to a user usage information on the indicator.

The indicator may comprise any suitable indicator. The indicator may comprise at least one of a visual indicator, an audible indicator, and a tactile indicator. The visual indicator may comprise a display or one or more light emitting diodes. The audible indicator may comprise a loudspeaker or a buzzer. The tactile indicator may comprise an actuator. Where the indicator comprises a display, the indicator may be configured to display usage information in the form of at least one of numbers, graphics, charts and graphs. For example, the display may be configured to display the number of puffs remaining in numerals, and may be configured to display a depletion level of the aerosol-forming substrate as a pie graph. In some preferred embodiments, the aerosol-generating device further comprises a display coupled to the controller, and the controller is configured to display usage information on the display.

In some preferred embodiments, the aerosol-generating device further comprises a transmitter. The transmitter may be coupled to the controller. The controller may be configured to send a pressure measurement signal from the transmitter to an external device, the pressure measurement signal including pressure measurement information detected by the pressure detection apparatus. In some of these preferred embodiments, an external device, such as a server, is configured to receive the pressure measurement signal from the aerosol-generating device. The external device may be configured to process the pressure measurement information received in the pressure measurement signal from the aerosol-generating device. Advantageously, sending pressure measurement information from the aerosol-generating device to an external device for processing may reduce the processing load on the controller of the aerosol-generating device, enabling the controller of the aerosol-generating device to be made less powerful, smaller, and less expensive.

The external device may be configured to determine at least one of: a puff volume, a puff duration, an average puff volume, and average puff duration from the received pressure measurement information. The external device may be configured to send the determined puff volume, puff duration, average puff volume, or average puff duration to the aerosol-generating device. The receiver of the aerosol-generating device may be configured to receive the determined puff volume, puff duration, average puff volume, or average puff duration.

The external device may be configured to determine usage information from the received pressure measurement information. The external device may be configured to send a usage signal to the aerosol-generating device, the usage signal comprising the determined usage information. The receiver of the aerosol-generating device may be configured to receive the usage signal.

Where the aerosol-generating device comprises both a transmitter and a receiver, the transmitter and receiver may be combined in a single transceiver.

The aerosol-generating device may be configured to connect to an external device to transmit data to the external device. The aerosol-generating device may be configured to connect to an external device to receive data from the external device. The aerosol-generating device may be configured to connect to an external device in any suitable way. The aerosol-generating device may be configured to connect to an external device via a wired connection. The aerosol-generating device may be configured to connect to an external device via a wireless connection.

The aerosol-generating device may be configured to connect to an external device via a communication link that operates under any suitable interface standard. Examples of suitable interface standards for the communication link include the Recommended Standard 232 (RS-232) family of standards; Universal Serial Bus (USB); Bluetooth®; FireWire (a brand name of Apple, Inc. for their IEEE 1394 interface), IrDA (Infrared Data Association—a communications standard for the short-range exchange of data by Infrared light); ZigBee (a specification based on the IEEE 802.15.4 standard for wireless personal area networks) and other Wi-Fi standards.

The aerosol-generating device may comprise a user interface.

The user interface may be any suitable user interface. The user interface may comprise one or more physical user inputs, such as buttons or switches. The user interface may comprise a touch screen. Where the user interface comprises a touch screen, the one or more user inputs may be portions of the touch screen.

The user interface may be configured to activate the aerosol-generating device. For example, the aerosol-generating device may comprise a button to initiate supply of power to the aerosol generator to generate an aerosol from an aerosol-forming substrate.

The user interface may be configured to display a state of the device or of the aerosol-forming substrate.

Where the user interface is a graphical user interface (GUI), the user interface may be configured to display usage information from the controller.

According to the disclosure, there is provided an aerosol-generating system comprising an aerosol-generating device as described above and an aerosol-forming substrate.

Preferably, the aerosol-forming substrate is a solid aerosol-forming substrate. However, the aerosol-forming substrate may comprise both solid and liquid components. Alternatively, the aerosol-forming substrate may be a liquid aerosol-forming substrate.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article. Preferably, the aerosol-forming substrate comprises an aerosol former. As used herein, the term “aerosol former” is used to describe any suitable known compound or mixture of compounds that, in use, facilitates formation of an aerosol and that is substantially resistant to thermal degradation at the operating temperature of the aerosol-generating article.

Suitable aerosol-formers are known in the art and include, but are not limited to: polyhydric alcohols, such as propylene glycol, triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as propylene glycol, triethylene glycol, 1,3-butanediol and, most preferred, glycerine.

The aerosol-forming substrate may comprise a single aerosol former. Alternatively, the aerosol-forming substrate may comprise a combination of two or more aerosol formers.

In some preferred embodiments, the aerosol-forming substrate is provided in an aerosol-generating article.

Where the aerosol-generating system comprises an aerosol-generating article comprising the aerosol-forming substrate, the aerosol-generating article may comprise an article susceptor element. In particular, where the aerosol-generating device comprises an inductor coil, the aerosol-generating article may comprise a susceptor element.

The susceptor element may be arranged to heat the aerosol-forming substrate. Preferably, the article susceptor element is positioned in direct contact with the aerosol-forming substrate. Preferably, the article susceptor element is an internal susceptor element positioned within the aerosol-forming substrate.

The susceptor element may be arranged to be penetrated by the varying magnetic field generated by the inductor coil of the aerosol-generating article when the aerosol-generating article is inserted into the substrate cavity of the aerosol-generating device. Preferably, the aerosol-generating article is configured so that at least a portion of the article susceptor element is positioned within the inductor coil when the aerosol-generating article is inserted into the substrate cavity of the aerosol-generating device.

The article susceptor element may comprise any of the optional or preferred features described above with respect to a susceptor element forming part of the aerosol-generating device.

According to the present disclosure, there is provided a method of operating an aerosol-generating device, the method comprising:
measuring the pressure at or after a flow restriction of an airflow path of the aerosol-generating device; and
controlling a supply of power to an aerosol generator of the aerosol-generating device based on the pressure measurement.

In some preferred embodiments, the method further comprises:
determining an average pressure from a plurality of the pressure measurements;
determining the difference between a subsequent pressure measurement and the average pressure;
detecting a puff on the aerosol-generating device by determining whether the difference between the subsequent pressure measurement and the average pressure is indicative of a pressure drop corresponding to a puff on the aerosol-generating device by a user;
when a puff is detected, determining the difference between subsequent pressure measurements during the puff and the average pressure;
determining the duration of the puff from the differences between the subsequent pressure measurements and the average pressure;
summing, over the duration of the puff, the differences between the pressure measurements during the puff and the average pressure;
determining the volume of the puff based on the summed differences between the pressure measurements during the puff and the average pressure over the determined puff duration; and
the controlling the supply of power to the aerosol generator based on the pressure measurement comprises controlling the supply of power to the aerosol generator based on the determined puff volume.

According to the present disclosure, there is also provided another method of operating an aerosol-generating device, the method comprising:
measuring the pressure before a flow restriction of an airflow path of the aerosol-generating device during a puff on the aerosol-generating device;
measuring the pressure at or after the flow restriction of the airflow path during the puff on the aerosol-generating device;
determining the difference between pressure measurements before the flow restriction and pressure measurements at or after the flow restriction during the puff;
summing, over the duration of the puff, the differences between the pressure measurements before the flow restriction and the pressure measurements at or after the flow restriction;
determining the volume of the puff based on the summed differences between the pressure measurements before the flow restriction and the pressure measurements at or after the flow restriction over the puff duration; and
controlling a supply of power to an aerosol generator of the aerosol-generating device based on the determined puff volume.

In some embodiments, a puff may be detected based on measurements of the pressure before the flow restriction and the pressure at or after the flow restriction. In these embodiments, the method may comprise:
measuring the pressure before the flow restriction of the airflow path;
measuring the pressure at or after the flow restriction of the airflow path;
determining the difference between the pressure measurements before the flow restriction and the pressure measurements at or after the flow restriction; and
detecting a puff on the aerosol-generating device by determining whether the difference between the pressure measurements before the flow restriction and the pressure measurements at or after the flow restriction is indicative of a pressure drop corresponding to a puff on the aerosol-generating device.

The method may also comprise determining the duration of the puff from the differences between the pressure measurements before the flow restriction and the pressure measurements at or after the flow restriction during the puff.

According to the present disclosure, there is also provided another method of operating an aerosol-generating device, the method comprising:
measuring the pressure at the flow restriction during a puff on the aerosol-generating device;
measuring the pressure after the flow restriction during a puff on the aerosol-generating device;
determining the difference between pressure measurements at the flow restriction and pressure measurements after the flow restriction during the puff;
summing, over the duration of the puff, the differences between the pressure measurements at the flow restriction and the pressure measurements after the flow restriction;
determining the volume of the puff based on the summed differences between the pressure measurements at the flow restriction and the pressure measurements after the flow restriction over the puff duration; and
controlling a supply of power to an aerosol generator of the aerosol-generating device based on the determined puff volume.

In some embodiments, a puff may be detected based on measurements of the pressure at the flow restriction and the pressure after the flow restriction. In these embodiments, the method may comprise:
measuring the pressure at the flow restriction of the airflow path;
measuring the pressure after the flow restriction of the airflow path;
determining the difference between the pressure measurements at the flow restriction and the pressure measurements after the flow restriction; and
detecting a puff on the aerosol-generating device by determining whether the difference between the pressure measurements at the flow restriction and the pressure measurements after the flow restriction is indicative of a pressure drop corresponding to a puff on the aerosol-generating device by a user.

The method may also comprise determining the duration of the puff from the differences between the pressure measurements at the flow restriction and the pressure measurements after the flow restriction during the puff.

In all of the methods described above, the controlling the supply of power to the aerosol generator may comprise comparing the determined puff volume to a threshold value. Based on the comparison, the method may further comprise increasing the supply of power to the aerosol generator if the determined puff volume is above the threshold value. Based on the comparison, the method may further comprise decreasing the supply of power to the aerosol generator if the determined puff volume is below the threshold value. Based on the comparison, the method may further comprise increasing the duration of the supply of power to the aerosol generator if the determined puff volume is above the threshold value. Based on the comparison, the method may further comprise decreasing the duration of the supply of power to the aerosol generator if the determined puff volume is below the threshold value.

Preferably, the power supplied to the aerosol generator is supplied in pulses. Where the power supplied to the aerosol-generator is supplied in pulses, the supply of power to the aerosol generator may be controlled by pulse width modulation.

The method may further comprise determining, based on at least one of the determined puff volume and puff duration, a maximum number of puffs remaining, which corresponds to the maximum number of puffs a user is able take on the aerosol-generating device before the aerosol-generating substrate received in the substrate cavity is depleted.

The maximum number of puffs remaining may be determined based on an average of determined puff volumes for a plurality of puffs. The average may be one of the mean, median and mode puff volume. The average may be based on any suitable number of determined puff volumes. For example, the average may be based on at least two, three, four, five or six determined puff volumes. The average puff volume may be based on between 2 and 40 determined puff volumes The determined puff volumes on which the average is based may correspond to consecutive puffs on the aerosol-generating device.

The method may further comprise preventing the supply of power to the aerosol generator once the determined maximum number of puffs remaining has been reached.

The method may further comprise determining, based on at least one of the determined puff volume and puff duration, a maximum duration of time remaining for aerosol generation, which corresponds to a maximum duration of time power is able to be supplied to the aerosol generator before the aerosol-generating substrate received in the substrate cavity is depleted.

The maximum duration of time remaining for aerosol generation may be determined based on an average of determined puff durations for a plurality of puffs. The average may be one of the mean, median and mode puff duration. The average may be based on any suitable number of determined puff durations. For example, the average may be based on at least two, three, four, five or six determined puff durations. The average puff duration may be based on between 2 and 40 determined puff durations. The determined puff durations on which the average is based may correspond to consecutive puffs on the aerosol-generating device.

The method may further comprise preventing the supply of power to the aerosol generator once the determined maximum duration of time remaining for aerosol generation has been reached.

The method may further comprise determining usage information based on at least one of the determined puff volume and puff duration. The usage information is information regarding a user's puffing habits on the aerosol-generating device based on the pressure measurements.

The usage information may comprise at least one of:
a maximum number of puffs remaining, which corresponds to a maximum number of puffs a user a user is able take on the aerosol-generating device before the aerosol-generating substrate received in the substrate cavity is depleted;
a maximum duration of time remaining for aerosol generation, which corresponds to a maximum duration of time power is able to be supplied to the aerosol generator before the aerosol-generating substrate received in the substrate cavity is depleted;
a puff count, wherein the puff count is the number of puffs a user has taken on the aerosol-generating device for an aerosol-forming substrate received in the substrate cavity; and
a depletion level of the aerosol-forming substrate, the depletion level corresponding to a fraction or percentage of the aerosol-forming substrate that has not been consumed or depleted during use.

In some embodiments, the usage information is determined based on an average of determined puff volumes for a plurality of puffs. The average may be one of the mean, median and mode puff volume.

In some embodiments, the usage information is determined based on an average of determined puff durations for a plurality of puffs. The average may be one of the mean, median and mode puff duration.

The method may further comprise controlling a supply of power to an aerosol generator of the aerosol-generating device based on the usage information.

The method may further comprise indicating to a user determined usage information on the indicator.

In some embodiments, the method further comprises the aerosol-generating device sending a pressure measurement signal to an external device. The pressure measurement signal includes pressure measurement information detected by the pressure detection apparatus.

The method may further comprise determining usage information from the pressure measurement information. Where the aerosol-generating device has sent a pressure measurement signal to an external device, the determining of the usage information may occur away from the aerosol-generating device. For example, the aerosol-generating device may send the pressure measurement signal over a network to a server, and the determining of the usage information may occur in the server. The determining of the usage information may comprise determining at least one of: a puff volume and an average puff volume.

Where the determining of the usage information has occurred outside of the aerosol-generating device, in an external device, the method may further comprise the external device notifying the determined usage information to a user.

Where the determining of the usage information has occurred outside of the aerosol-generating device, in an external device, the method may further comprise the aerosol-generating device receiving a usage signal from an external device. The usage signal comprises usage information, the usage information being information regarding a user's puffing habits on the aerosol-generating device based on the pressure measurement information sent to the external device.

The method may further comprise the aerosol-generating device controlling a supply of power to an aerosol generator of the aerosol-generating device based on the received usage information.

The method may further comprise the aerosol-generating device notifying the received usage information to a user.

According to the present disclosure, there may be provided a controller of an aerosol-generating device, wherein the controller is configured to perform any of the methods described above.

It will be appreciated that any of the features and associated advantages of the aerosol-generating devices described above may be equally applicable to the methods described above. Similarly, any of the features and associated benefits of the methods described above may be equally applicable to the aerosol-generating devices described above.

The invention is defined in the claims. However, below there is provided a non-exhaustive list of non-limiting examples. Any one or more of the features of these examples may be combined with any one or more features of another example, embodiment, or aspect described herein.
1. An aerosol-generating device comprising:
a substrate cavity configured to receive an aerosol-forming substrate;
an airflow path extending between an inlet and the substrate cavity;
a flow restriction located in the airflow path; and
pressure detection apparatus configured to detect the pressure in the airflow path at or after the flow restriction, between the flow restriction and the substrate cavity.
2. An aerosol-generating device according to example 1, wherein the pressure detection apparatus is configured to detect the pressure in the airflow path either:
before the flow restriction, between the inlet and the flow restriction and at or after the flow restriction, between the flow restriction and the substrate cavity; or
at the flow restriction and after the flow restriction, between the flow restriction and the substrate cavity.
3. An aerosol-generating device according to example 2, wherein the pressure detection apparatus comprises either:
a first pressure sensor configured to detect the pressure in the airflow path before the flow restriction, and a second pressure sensor configured to detect the pressure in the airflow path at or after the flow restriction; or
a first pressure sensor configured to detect the pressure in the airflow path at the flow restriction, and a second pressure sensor configured to detect the pressure in the airflow path after the flow restriction.
4. An aerosol-generating device according to example 2, wherein the pressure detection apparatus comprises a differential pressure sensor configured to detect either:
the difference between the pressure in the airflow path before the flow restriction and the pressure in the airflow path at or after the flow restriction; or
the difference between the pressure at the flow restriction and the pressure after the flow restriction.
5. An aerosol-generating device according to example 1, wherein:
   the pressure detection apparatus comprises a pressure sensor configured to detect the pressure in the airflow path either at or after the flow restriction; and
   the aerosol-generating device further comprises a controller, wherein the controller is configured to:
   receive pressure measurement information from the pressure detection apparatus; and
   determine a puff volume based on pressure measurement information received from the pressure detection apparatus, wherein the puff volume is the volume of a puff taken by a user on the aerosol-generating device.
6. An aerosol-generating device according to example 5, wherein the controller is configured to determine the puff volume by:
   determining an average pressure from a plurality of the pressure measurements;
   determining a change in a subsequent pressure measurement from the determined average pressure, the change being indicative of a pressure drop corresponding to a puff on the aerosol-generating device by a user;
   summing, over the duration of the puff, the determined differences between the pressure measurements during a determined puff and the determined average pressure; and
   determining the volume of the puff based on the summed determined differences over the determined puff duration.
7. An aerosol-generating device according to any one of examples 1 to 4, wherein the aerosol-generating device further comprises a controller, and wherein the controller is configured to receive pressure measurement information from the pressure detection apparatus.
8. An aerosol-generating device according to any one of examples 5 to 7, wherein the pressure measurement information comprises at least one of:
the pressure before the flow restriction;
the pressure at the flow restriction;
the pressure after the flow restriction;
the difference between the pressure before the flow restriction and the pressure at or after the flow restriction;
the difference between the pressure at the flow restriction and the pressure after the flow restriction; and
a puff duration, wherein the puff duration is the duration of a puff on the aerosol-generating device.
9. An aerosol-generating device according to any one of examples 4 to 6, wherein the aerosol-generating device further comprises a controller, wherein the controller is configured to receive pressure measurement information from the pressure detection apparatus, and wherein the controller is configured to determine a puff volume based on either the difference between the pressure measured before the flow restriction and the pressure measured at or after the flow restriction by the pressure detection apparatus or the difference between the pressure measured at the flow restriction and the pressure measured after the flow restriction by the pressure detection apparatus, wherein the puff volume is the volume of a puff taken by a user on the aerosol-generating device.
10. An aerosol-generating device according to example 10, wherein the pressure measurement information comprises at least one of:
the pressure before the flow restriction;
the pressure at the flow restriction;
the pressure after the flow restriction
the difference between the pressure before the flow restriction and the pressure at or after the flow restriction;
the difference between the pressure at the flow restriction and the pressure after the flow restriction and
the duration of a puff on the aerosol-generating device.
11. An aerosol-generating device according to any one of examples 1 to 10, wherein the aerosol-generating device comprises an aerosol generator configured to generate an aerosol from an aerosol-forming substrate received in the substrate cavity.
12. An aerosol-generating device according to any one of examples 5 to 10, wherein the aerosol-generating device comprises an aerosol generator configured to generate an aerosol from an aerosol-forming substrate received in the substrate cavity, and wherein the controller is configured to control a supply of power to the aerosol generator based on the received pressure measurement information.
13. An aerosol-generating device according to any one of examples 5 to 10, wherein the aerosol-generating device comprises an aerosol generator configured to generate an aerosol from an aerosol-forming substrate received in the substrate cavity, and wherein the controller is configured to control a supply of power to the aerosol generator based on the determined puff volume.
14. An aerosol-generating device according to any one of examples 5 to 10, wherein the aerosol-generating device comprises an aerosol generator configured to generate an aerosol from an aerosol-forming substrate received in the substrate cavity, and wherein the controller is configured to control a supply of power to the aerosol generator based on the determined puff volume and the determined puff duration.
15. An aerosol-generating device according to any one of examples 12, 13 or 14, wherein the aerosol-generating device further comprises a power supply configured to supply power to the aerosol generator, and wherein the controller is configured to control the supply of power from the power supply to the aerosol generator, and optionally wherein the power supply comprises at least one of a battery and a capacitor.
16. An aerosol-generating device according to any one of examples 12 to 15, wherein the aerosol generator comprises a resistive heating element.
17. An aerosol-generating device according to example 16, wherein the resistive heating element is located in or around the substrate cavity and is configured to heat an outer surface of an aerosol-forming substrate received in the substrate cavity.
18. An aerosol-generating device according to example 16, wherein the resistive heating element is located in the substrate cavity and is configured to pierce an aerosol-forming substrate received in the substrate cavity and heat the aerosol-forming substrate from the inside.
19. An aerosol-generating device according to any one of examples 12 to 15, wherein the aerosol generator comprises an inductor coil.
20. An aerosol-generating device according to example 19, wherein the inductor coil is configured to generate a varying magnetic field in the substrate cavity, optionally wherein the inductor coil is located in or around the substrate cavity, and optionally wherein the inductor coil circumscribes the substrate cavity.
21. An aerosol-generating device according to example 19 or example 20, wherein the aerosol-generating device further comprises a susceptor element, wherein the inductor coil is configured to generate a varying magnetic field that penetrates the susceptor element.
22. An aerosol-generating device according to example 21, wherein the susceptor element is located in or around the substrate cavity and is configured to heat an outer surface of an aerosol-forming substrate received in the substrate cavity.
23. An aerosol-generating device according to example 21, wherein the susceptor element is located in the substrate cavity and is configured to pierce an aerosol-forming substrate received in the substrate cavity and heat the aerosol-forming substrate from the inside.
24. An aerosol-generating device according to any one of examples 12 to 23, wherein the controller is configured to compare the determined puff volume to a threshold value, and based on the comparison the controller is configured to increase the supply of power to the aerosol generator if the determined puff volume is above the threshold value.
25. An aerosol-generating device according to any one of examples 12 to 24, wherein the controller is configured to compare the determined puff volume to a threshold value, and based on the comparison the controller is configured to decrease the supply of power to the aerosol generator if the determined puff volume is below the threshold value.
26. An aerosol-generating device according to any one of examples 12 to 25, wherein the controller is configured to compare the determined puff volume to a threshold value, and based on the comparison the controller is configured to increase the duration of the supply of power to the aerosol generator if the determined puff volume is above the threshold value.
27. An aerosol-generating device according to any one of examples 12 to 26, wherein the controller is configured to compare the determined puff volume to a threshold value, and based on the comparison the controller is configured to decrease the duration of the supply of power to the aerosol generator if the determined puff volume is below the threshold value.
28. An aerosol-generating device according to any one of examples 12 to 27, wherein the controller is configured to control the supply of power to the aerosol generator in pulses, and wherein the controller is configured to control the supply of power to the aerosol generator by pulse width modulation.
29. An aerosol-generating device according to any one of examples 5 to 10 or 12 to 28, wherein the controller is configured to determine, based on at least one of the determined puff volume and puff duration, at least one of:
a maximum number of puffs remaining, which corresponds to the maximum number of puffs a user is able take on the aerosol-generating device before the aerosol-generating substrate received in the substrate cavity is depleted; and
a maximum duration of time remaining for aerosol generation, which corresponds to a maximum duration of time power is able to be supplied to the aerosol generator before the aerosol-generating substrate received in the substrate cavity is depleted, and
   optionally wherein the maximum number of puffs remaining is determined based on an average of determined puff volumes for a plurality of puffs, and optionally wherein the average is one of the mean, median and mode volume; and
   optionally wherein the maximum duration of time remaining for aerosol generation is determined based on an average of determined puff durations for a plurality of puffs, and optionally wherein the average is one of the mean, median and mode puff duration.
30. An aerosol-generating device according to example 29, wherein the controller is configured to prevent the supply of power to the aerosol generator once at least one of:
the determined maximum number of puffs remaining has been reached; and
the determined maximum duration of time remaining for aerosol generation has been reached.
31. An aerosol-generating device according to any one of examples 5 to 10 or 12 to 30, wherein the aerosol-generating device further comprises a transmitter, and wherein the aerosol-generating device is configured to send a pressure measurement signal from the transmitter to an external device, the pressure measurement signal including pressure measurement information detected by the pressure detection apparatus.
32. An aerosol-generating device according to example 31, wherein the aerosol-generating device comprises a receiver, and wherein the receiver is configured to receive a usage signal from an external device, the usage signal comprising usage information, the usage information being information regarding a user's puffing habits on the aerosol-generating device based on the pressure measurement information sent to the external device.
33. An aerosol-generating device according to any one of examples 5 to 10 or 12 to 32, wherein the controller is configured to determine usage information based on at least one of the determined puff volume and puff duration, and optionally, where the aerosol-generating device comprises an aerosol generator, the controller is configured to control a supply of power to the aerosol generator based on the usage information.
34. An aerosol-generating device according to example 32 or example 33, wherein the aerosol-generating device further comprises an indicator coupled to the controller, and wherein the controller is configured to indicate to a user usage information on the indicator, and optionally wherein the indicator comprises at least one of a visual indicator, an audible indicator, and a tactile indicator.
35. An aerosol-generating device according to any one of examples 32, 33 or 34, wherein the aerosol-generating device further comprises a display coupled to the controller, and wherein the controller is configured to display usage information on the display.
36. An aerosol-generating device according to example 35, wherein the usage information comprises at least one of:
a maximum number of puffs remaining, which corresponds to a maximum number of puffs a user a user is able take on the aerosol-generating device before the aerosol-generating substrate received in the substrate cavity is depleted;
a maximum duration of time remaining for aerosol generation, which corresponds to a maximum duration of time power is able to be supplied to the aerosol generator before the aerosol-generating substrate received in the substrate cavity is depleted;
a puff count, wherein the puff count is the number of puffs a user has taken on the aerosol-generating device for an aerosol-forming substrate received in the substrate cavity; and
a depletion level of the aerosol-forming substrate, the depletion level corresponding to a fraction or percentage of the aerosol-forming substrate that has not been consumed or depleted during use.
37. An aerosol-generating device according to example 35 or example 36, wherein the usage information is determined based on at least one of:
an average of determined puff volumes for a plurality of puffs, optionally wherein the average is one of the mean, median and mode volume; and
an average of determined puff durations for a plurality of puffs, optionally wherein the average is one of the mean, median and mode puff duration.
38. A method for determining the volume of a puff on an aerosol-generating device, the method comprising:
measuring the pressure at or after a flow restriction of an airflow path of the aerosol-generating device;
determining an average pressure from a plurality of the pressure measurements;
determining the difference between a subsequent pressure measurement and the average pressure;
detecting a puff on the aerosol-generating device by determining whether the difference between the subsequent pressure measurement and the average pressure is indicative of a pressure drop corresponding to a puff on the aerosol-generating device by a user;
when a puff is detected, determining the difference between subsequent pressure measurements during the puff and the average pressure;
determining the duration of the puff from the differences between the subsequent pressure measurements and the average pressure;
summing, over the duration of the puff, the differences between the pressure measurements during the puff and the average pressure; and
determining the volume of the puff based on the summed differences between the pressure measurements during the puff and the average pressure over the determined puff duration.
39. A method for determining the volume of a puff on an aerosol-generating device, the method comprising:
measuring the pressure before a flow restriction of an airflow path of the aerosol-generating device during a puff on the aerosol-generating device;
measuring the pressure at or after a flow restriction of an airflow path of the aerosol-generating device during a puff on the aerosol-generating device;
determining the difference between pressure measurements before the flow restriction and pressure measurements at or after the flow restriction during the puff;
determining the duration of the puff from the differences between the pressure measurements before the flow restriction and the pressure measurements at or after the flow restriction during the puff;
summing, over the duration of the puff, the differences between the pressure measurements before the flow restriction and the pressure measurements at or after the flow restriction; and
determining the volume of the puff based on the summed differences between the pressure measurements before the flow restriction and the pressure measurements at or after the flow restriction over the puff duration.
40. A method for determining the volume of a puff on an aerosol-generating device, the method comprising:
measuring the pressure at a flow restriction of an airflow path of the aerosol-generating device during a puff on the aerosol-generating device;
measuring the pressure after the flow restriction of an airflow path of the aerosol-generating device during a puff on the aerosol-generating device;
determining the difference between pressure measurements at the flow restriction and pressure measurements after the flow restriction during the puff;
determining the duration of the puff from the differences between the pressure measurements at flow restriction and the pressure measurements after the flow restriction during the puff;
summing, over the duration of the puff, the differences between the pressure measurements at the flow restriction and the pressure measurements after the flow restriction; and
determining the volume of the puff based on the summed differences between the pressure measurements at the flow restriction and the pressure measurements after the flow restriction over the puff duration.
41. A method of operating an aerosol-generating device, the method comprising:
measuring the pressure at or after a flow restriction of an airflow path of the aerosol-generating device; and
controlling a supply of power to an aerosol generator of the aerosol-generating device based on the pressure measurement.
42. A method of operating an aerosol-generating device, the method comprising:
measuring the pressure at or after a flow restriction of an airflow path of the aerosol-generating device;
determining an average pressure from a plurality of the pressure measurements;
determining the difference between a subsequent pressure measurement and the average pressure;
detecting a puff on the aerosol-generating device by determining whether the difference between the subsequent pressure measurement and the average pressure is indicative of a pressure drop corresponding to a puff on the aerosol-generating device by a user;
when a puff is detected, determining the difference between subsequent pressure measurements during the puff and the average pressure;
determining the duration of the puff from the differences between the subsequent pressure measurements and the average pressure;
summing, over the duration of the puff, the differences between the pressure measurements during the puff and the average pressure;
determining the volume of the puff based on the summed differences between the pressure measurements during the puff and the average pressure over the determined puff duration; and
controlling a supply of power to an aerosol generator of the aerosol-generating device based on the determined puff volume.
43. A method of operating an aerosol-generating device, the method comprising:
measuring the pressure before a flow restriction of an airflow path of the aerosol-generating device;
measuring the pressure at or after the flow restriction of the airflow path;
determining the difference between the pressure measurements before the flow restriction and the pressure measurements at or after the flow restriction;
detecting a puff on the aerosol-generating device by determining whether the difference between the pressure measurements before the flow restriction and the pressure measurements at or after the flow restriction is indicative of a pressure drop corresponding to a puff on the aerosol-generating device by a user;
when a puff is detected, determining the difference between pressure measurements before the flow restriction and pressure measurements at or after the flow restriction during the puff;
determining the duration of the puff from the differences between the pressure measurements before the flow restriction and the pressure measurements at or after the flow restriction during the puff;
summing, over the duration of the puff, the differences between the pressure measurements before the flow restriction and the pressure measurements at or after the flow restriction;
determining the volume of the puff based on the summed differences between the pressure measurements before the flow restriction and the pressure measurements at or after the flow restriction over the puff duration; and
controlling a supply of power to an aerosol generator of the aerosol-generating device based on the determined puff volume.
44. A method of operating an aerosol-generating device, the method comprising:
measuring the pressure at a flow restriction of an airflow path of the aerosol-generating device; measuring the pressure after the flow restriction of the airflow path;
determining the difference between the pressure measurements at the flow restriction and the pressure measurements after the flow restriction;
detecting a puff on the aerosol-generating device by determining whether the difference between the pressure measurements at the flow restriction and the pressure measurements after the flow restriction is indicative of a pressure drop corresponding to a puff on the aerosol-generating device by a user;
when a puff is detected, determining the difference between pressure measurements at the flow restriction and pressure measurements after the flow restriction during the puff;
determining the duration of the puff from the differences between the pressure measurements at flow restriction and the pressure measurements after the flow restriction during the puff;
summing, over the duration of the puff, the differences between the pressure measurements at the flow restriction and the pressure measurements after the flow restriction;
determining the volume of the puff based on the summed differences between the pressure measurements at the flow restriction and the pressure measurements after the flow restriction over the puff duration; and
controlling a supply of power to an aerosol generator of the aerosol-generating device based on the determined puff volume.
45. A method according to any one of examples 42 to 44, wherein at least one of:
   the controlling the supply of power to the aerosol generator comprises comparing the determined puff volume to a threshold value, and, based on the comparison, increasing the supply of power to the aerosol generator if the determined puff volume is above the threshold value; and
   the controlling the supply of power to the aerosol generator comprises comparing the determined puff volume to a threshold value, and, based on the comparison, decreasing the supply of power to the aerosol generator if the determined puff volume is below the threshold value.
46. A method according to any one of examples 42 to 45, wherein the controlling the supply of power to the aerosol generator comprises comparing the determined puff volume to a threshold value, and, based on the comparison, either increasing the duration of the supply of power to the aerosol generator if the determined puff volume is above the threshold value, or decreasing the duration of the supply of power to the aerosol generator if the determined puff volume is below the threshold value.
47. A method according to any one of examples 41 to 46, wherein the power to the aerosol generator is supplied in pulses, and the supply of power to the aerosol generator is controlled by pulse width modulation.
48. A method according to any one of examples 41 to 47, further comprising determining, based on at least one of the determined puff volume and puff duration, at least one of:
a maximum number of puffs remaining, which corresponds to the maximum number of puffs a user is able take on the aerosol-generating device before the aerosol-generating substrate received in the substrate cavity is depleted; and
a maximum duration of time remaining for aerosol generation, which corresponds to a maximum duration of time power is able to be supplied to the aerosol generator before the aerosol-generating substrate received in the substrate cavity is depleted, and
   optionally wherein the maximum number of puffs remaining is determined based on an average of determined puff volumes for a plurality of puffs, and optionally wherein the average is one of the mean, median and mode volume; and
   optionally wherein the maximum duration of time remaining for aerosol generation is determined based on an average of determined puff durations for a plurality of puffs, and optionally wherein the average is one of the mean, median and mode puff duration.
49. A method according to example 48, further comprising preventing the supply of power to the aerosol generator once at least one of:
the determined maximum number of puffs remaining has been reached or is determined to be zero; and
the determined maximum duration of time remaining for aerosol generation has been reached or is determined to be zero.
50. A method according to any one of examples 41 to 48, further comprising determining usage information based on at least one of the determined puff volume and puff duration, and optionally wherein the usage information comprises at least one of:
a maximum number of puffs remaining, which corresponds to a maximum number of puffs a user a user is able take on the aerosol-generating device before the aerosol-generating substrate received in the substrate cavity is depleted;
a maximum duration of time remaining for aerosol generation, which corresponds to a maximum duration of time power is able to be supplied to the aerosol generator before the aerosol-generating substrate received in the substrate cavity is depleted;
a puff count, wherein the puff count is the number of puffs a user has taken on the aerosol-generating device for an aerosol-forming substrate received in the substrate cavity; and
a depletion level of the aerosol-forming substrate, the depletion level corresponding to a fraction or percentage of the aerosol-forming substrate that has not been consumed or depleted during use.
51. A method according to example 50, wherein the usage information is determined based on an average of determined puff volumes for a plurality of puffs, and optionally wherein the average is one of the mean, median and mode volume.
52. A method according to example 50 or example 51, wherein the usage information is determined based on an average of determined puff durations for a plurality of puffs, and optionally wherein the average is one of the mean, median and mode puff duration.
53. A method according to any one of examples 50 to 52, further comprising at least one of:
controlling a supply of power to an aerosol generator of the aerosol-generating device based on the usage information; and
indicating to a user determined usage information on the indicator.
54. A method according to any one of examples 38 to 53, further comprising the aerosol-generating device sending a pressure measurement signal to an external device, the pressure measurement signal including pressure measurement information detected by the pressure detection apparatus.
55. A method according to example 54, further comprising determining usage information from the pressure measurement information, the determining of the usage information occurring away from the aerosol-generating device, and optionally determining at least one of: a puff volume and an average puff volume away from the aerosol-generating device.
56. A method according to example 55, further comprising the external device notifying the determined usage information to a user.
57. A method according to any one of examples 54, 55 or 56, further comprising the aerosol-generating device receiving a usage signal from an external device, the usage signal comprising usage information, the usage information being information regarding a user's puffing habits on the aerosol-generating device based on the pressure measurement information sent to the external device.
58. A method according to example 57, further comprising at least one of:
the aerosol-generating device controlling a supply of power to an aerosol generator of the aerosol-generating device based on the received usage information; and
the aerosol-generating device notifying the received usage information to a user.
59. A controller of an aerosol-generating device, the controller being configured to perform the methods of any one of examples 38 to 58.

The invention is further described, by way of example only, with reference to the accompanying drawings in which:

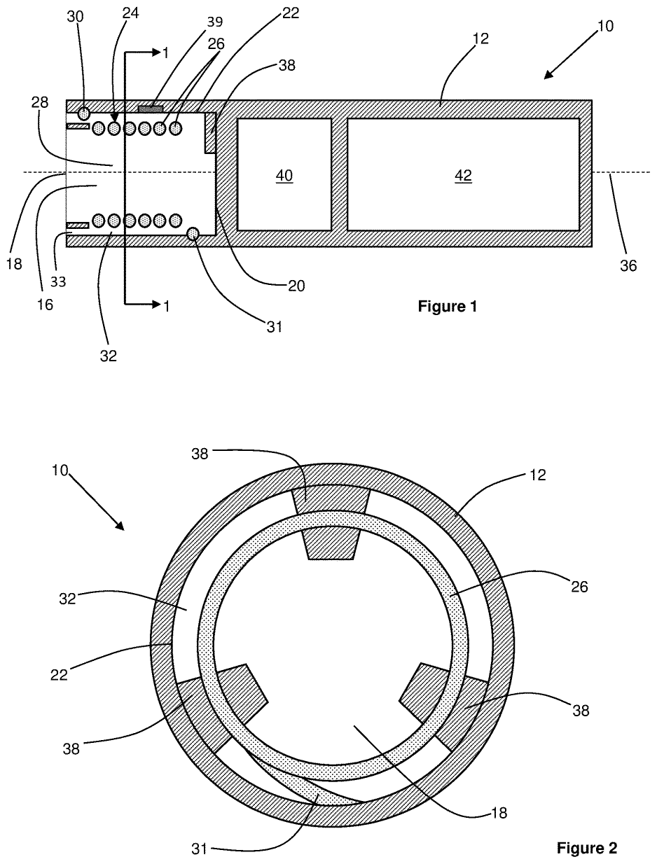

FIG. 1 shows a side cross-sectional view of an aerosol-generating device according to an embodiment of the disclosure;

FIG. 2 shows an axial cross-sectional view of the aerosol-generating device of FIG. 1 along line 1-1;

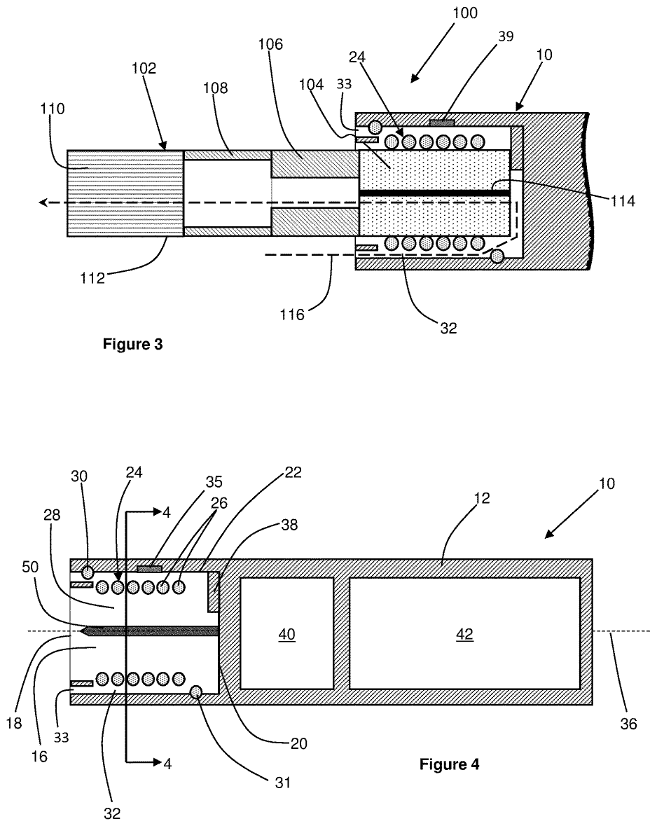

FIG. 3 shows a side cross-sectional view of an aerosol-generating system comprising the aerosol-generating device of FIG. 1;

FIG. 4 shows a side cross-sectional view of an aerosol-generating device according to another embodiment of the disclosure;

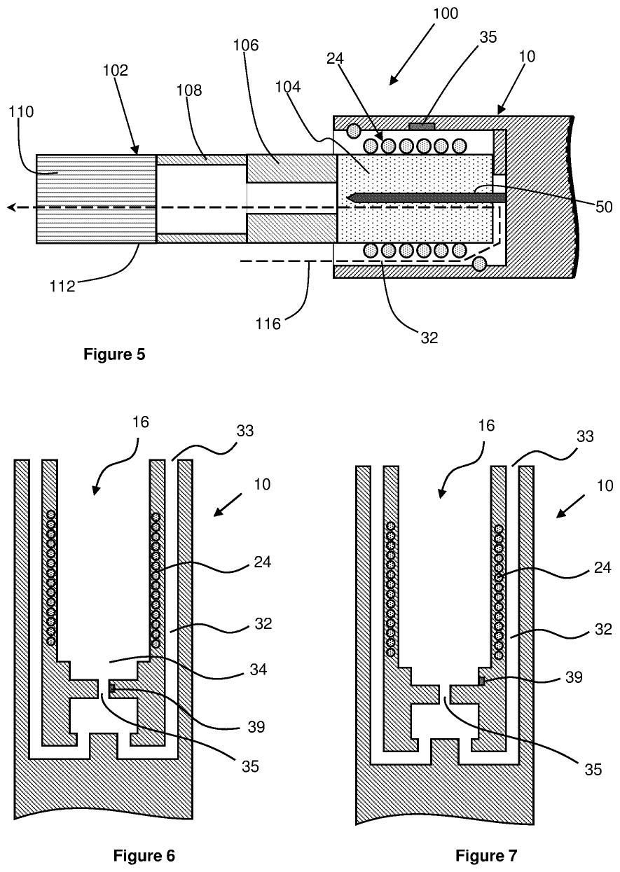

FIG. 5 shows a side cross-sectional view of an aerosol-generating system comprising the aerosol-generating device of FIG. 4;

FIG. 6 shows a side cross-sectional view of a portion of an aerosol-generating device according to another embodiment of the disclosure;

FIG. 7 shows a side cross-sectional view of a portion of an aerosol-generating device according to another embodiment of the disclosure;

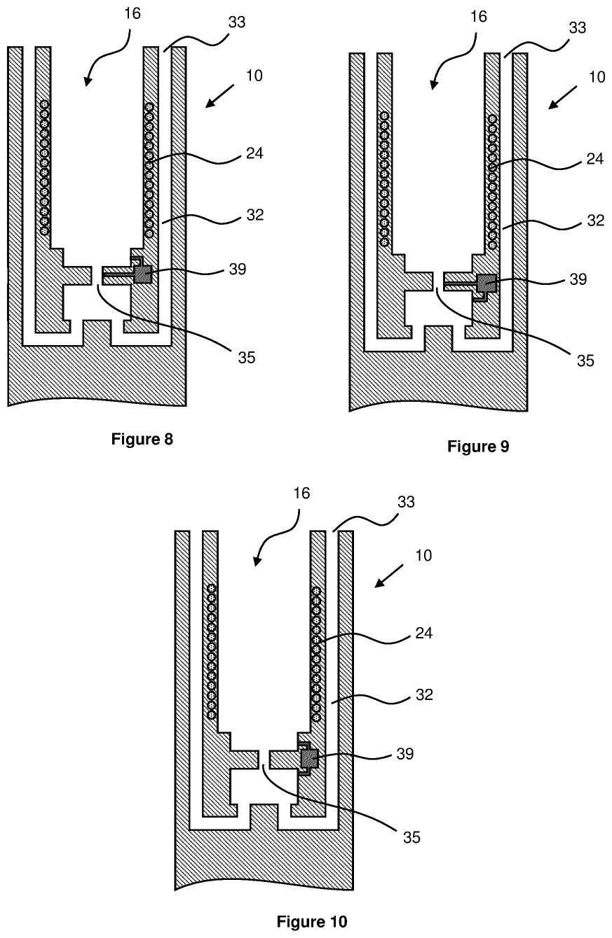

FIG. 8 shows a side cross-sectional view of a portion of an aerosol-generating device according to another embodiment of the disclosure;

FIG. 9 shows a side cross-sectional view of a portion of an aerosol-generating device according to another embodiment of the disclosure;

FIG. 10 shows a side cross-sectional view of a portion of an aerosol-generating device according to another embodiment of the disclosure;

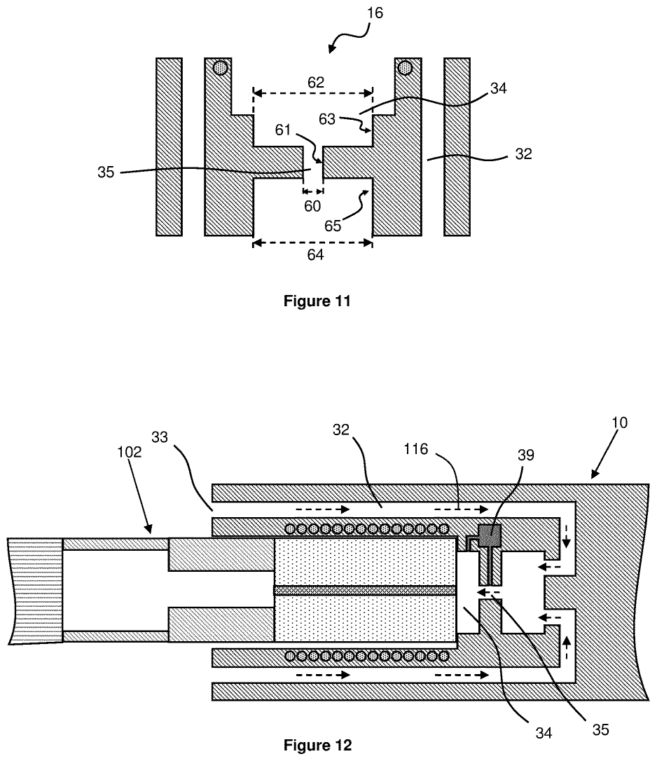

FIG. 11 shows a side cross-sectional view of a portion of the aerosol-generating devices of FIGS. 6-10;

FIG. 12 shows a side cross-sectional view of a portion of an aerosol-generating system comprising the aerosol-generating device of FIG. 8;

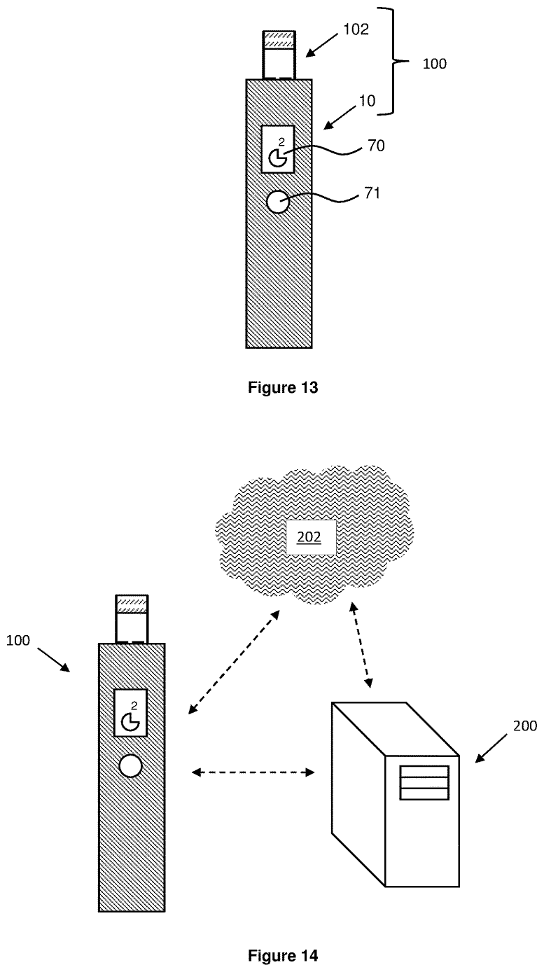

FIG. 13 shows a front view of the aerosol-generating system of FIG. 12; and

FIG. 14 shows an illustration of the aerosol-generating system of FIG. 12 in communication with other devices and networks.

FIGS. 1 and 2 show an aerosol-generating device 10 in accordance with a first embodiment. The aerosol-generating device 10 comprises a housing 12 defining a substrate cavity 16 for receiving a portion of an aerosol-generating article. The substrate cavity 16 comprises an open end 18 through which an aerosol-generating article may be inserted into the substrate cavity 16 and a closed end 20 opposite the open end 18. A cylindrical wall 22 of the substrate cavity 16 extends between the open end 18 and the closed end 20.

The aerosol-generating device 10 also comprises an inductor coil 24 comprising a plurality of windings 26 disposed within the substrate cavity 16. The plurality of windings 26 of the inductor coil 24 define a lumen 28 in which a portion of an aerosol-generating article is received when the aerosol-generating article is inserted into the substrate cavity 16. Advantageously, positioning the inductor coil 24 in direct contact with an aerosol-generating article received within the substrate cavity 16 facilitates the transfer of heat generated by resistive heating of the inductor coil 24 to the aerosol-generating article.

The inductor coil 24 comprises a first end 30 positioned towards the open end 18 of the substrate cavity 16 and a second end 31 positioned towards the closed end 20 of the substrate cavity 16. Each of the first end 30 and the second end 31 is received within a portion of the cylindrical wall 22 of the substrate cavity 16 to retain the inductor coil 24 within the substrate cavity 16. The cylindrical wall 22 of the substrate cavity 16 may define first and second recesses, slots, or apertures in which the first and second ends 30, 31 of the inductor coil 24 are respectively received. Alternatively, the first and second ends 30, 31 of the inductor coil 24 may be secured to the cylindrical wall 22 of the substrate cavity 16 by overmoulding the housing 12 over the first and second ends 30, 31 of the inductor coil 24 during manufacture of the housing 12.

The inductor coil 24 is suspended within the substrate cavity 16 by the first and second ends 30, 31 of the inductor coil 24 so that the windings 26 of the inductor coil 24 are spaced apart from the cylindrical wall 22 of the substrate cavity 16. Therefore, the inductor coil 24 contacts the housing 12 only at the first and second ends 30, 31 of the inductor coil 24. Spacing the windings 26 of the inductor coil 24 from the cylindrical wall 22 of the substrate cavity 16 defines an annular gap 32 between the cylindrical wall 22 of the substrate cavity 16 and the windings 26 of the inductor coil 24. Advantageously, the annular gap 32 reduces or minimises the transfer of heat generated by resistive heating of the inductor coil 24 to the housing 12. Advantageously, the annular gap 32 facilitates airflow through the substrate cavity 16 when an aerosol-generating article is received within the substrate cavity 16.

A plurality of inlets 33, in the form of cylindrical openings through the housing 12, are provided in the housing 12 around the open end 18 of the substrate cavity 16. In this embodiments, 17 inlets are provided, each inlet having a diameter of about 0.5 millimetres. Each inlet 33 provides a route for ambient air from outside the aerosol-generating device 10 to be drawn into the annular gap 32.

To facilitate insertion of an aerosol-generating article into the substrate cavity 16, the inductor coil 24 is arranged concentrically about a central axis 36 of the aerosol-generating device 10. To facilitate a secure positioning of the inductor coil 24 in the substrate cavity 16, the first and second ends 30, 31 of the inductor coil 24 are retained by diametrically opposed portions of the cylindrical wall 22 of the substrate cavity 16.

The housing 12 also defines a plurality of protrusions 38 extending into the substrate cavity 16 from the closed end 20 of the substrate cavity 16. As will be further described below, the plurality of protrusions 38 function to maintain a gap between an end of an aerosol-generating article and the closed end 20 of the substrate cavity 16 when the aerosol-generating article is fully inserted into the substrate cavity 16. In the embodiment shown in FIGS. 1 and 2, the housing 12 defines three protrusions 38 spaced equidistantly about the central axis 36 of the aerosol-generating device 10. The skilled person will appreciate that the housing 12 may define more or fewer protrusions 38 and the arrangement of the protrusions 38 at the closed end 20 of the substrate cavity 16 may be varied.

The aerosol-generating device 10 also comprises a pressure sensor 39 arranged in the annular gap 32. The pressure sensor is a MEMS absolute pressure sensor that senses the absolute pressure in the annular gap 32. The plurality of openings 33 and the annular gap 32 form an airflow path through which ambient air may be drawn into the substrate cavity 16 of the aerosol-generating device 10. The plurality of openings provide a flow restriction in the airflow path, increasing the resistance to draw through the airflow path and causing a pressure drop in the airflow path when a user puffs on the aerosol-generating device. The size of the pressure drop is measurable by the pressure sensor 39, and measurements of the pressure drop enable the aerosol-generating device 10 to determine the volume of a puff of a user, as described in more detail below.

The aerosol-generating device 10 also comprises control circuitry comprising a controller 40 and a power supply 42 connected to the inductor coil 24. The control circuitry is configured to provide an alternating electric current from the power supply 42 to the inductor coil 24 to generate an alternating magnetic field.

FIG. 3 shows a cross-sectional view of an aerosol-generating system 100 comprising the aerosol-generating device 10 of FIG. 1 and an aerosol-generating article 102.

The aerosol-generating article 102 comprises an aerosol-forming substrate 104 in the form of a tobacco plug, a first hollow acetate tube 106, a second hollow acetate tube 108, a mouthpiece 110, and an outer wrapper 112. The aerosol-generating article 102 also comprises a susceptor element 114 arranged within the aerosol-forming substrate 104. During use, a portion of the aerosol-generating article 102 is inserted into the substrate cavity 16 and the inductor coil 24 so that the aerosol-forming substrate 104 and the susceptor element 114 are positioned inside the lumen 28 defined by the inductor coil 24. The control circuitry provides an alternating electric current from the power supply 42 to the inductor coil 24 to generate an alternating magnetic field that inductively heats the susceptor element 114, which heats the aerosol-forming substrate 104 to generate an aerosol. As is described in more detail below, the level of inductive coupling between the inductor coil 24 and the susceptor element 114 (and consequently, the heating of the susceptor 114) is affected by the frequency of the alternating current supplied to the inductor coil 24.

Airflow through the aerosol-generating system 100 during use is illustrated by the dashed line 116 in FIG. 3. When a user draws on the mouthpiece 110 of the aerosol-generating article 102, a negative pressure is generated in the substrate cavity 16. The negative pressure draws air into the substrate cavity 16 via the open end 18 of the substrate cavity 16. The air entering the substrate cavity 16 then flows through the annular gap 32 between the inductor coil 24 and the cylindrical wall 22 of the substrate cavity 16. The pressure sensor 39 measure the pressure in the annular gap 32, and sends pressure measurement information to the controller 40. The controller detects that a puff is being taken on the aerosol-generating device 10 from the pressure drop caused by the airflow through the annular gap 32, as described in more detail below. When the airflow reaches the closed end 20 of the substrate cavity 16, the air enters the aerosol-generating article 102 through the aerosol-forming substrate 104. Airflow into the aerosol-generating article 102 is facilitated by the gap maintained between the upstream end of the aerosol-generating article 102 and the closed end 20 of the substrate cavity 16 by the plurality of protrusions 38. As the airflow passes through the aerosol-forming substrate 104, aerosol generated by heating of the aerosol-forming substrate 104 is entrained in the airflow. The aerosol then flows along the length of the aerosol-generating article 102 and through the mouthpiece 110 to the user.

The controller 40 is configured to detect a puff on the aerosol-generating device 10, and determine the volume of the puff, based on pressure measurement information received from the pressure sensor 39.

The controller 40 uses a plurality of pressure measurements from the pressure sensor 39 to determine a moving average pressure in the annular gap 32. In this embodiment, the controller 40 uses 20 consecutive pressure measurements to determine the average, and updates the average each time a new pressure measurement is received. Pressure measurements are taken at a sampling rate of about 75 Hertz, which equates to roughly 1 pressure measurement every 13.3 milliseconds. For each new pressure measurement, the controller 40 determines the difference between the new pressure measurement and the moving average, before updating the moving average with the new pressure measurement. The controller 40 is configured to detect that a puff is being taken on the aerosol-generating device 10 by comparing the difference to a threshold. If the difference is above the threshold, this is indicative of a pressure drop corresponding to a puff on the aerosol-generating device.

If a puff is detected, the controller 40 does not update the moving average with the new pressure measurement. The controller 40 continues to determine the difference between each new pressure measurement during the puff and compare the difference to the threshold to determine when the puff has ended. The controller 40 determines that the puff has ended when the difference between the new pressure measurement and the moving average, which has not been updated since the puff was detected, is below the threshold, indicating that the pressure drop cause by the airflow in the annular gap 32 has ended.

The controller 40 is also configured to determine the duration of the puff from the period of time between the first pressure measurement when the puff was detected, and the pressure measurement when the puff ended.

The controller 40 is further configured to determine the volume of the puff by summing, over the duration of the puff, the differences between the pressure measurements during the puff and the moving average pressure. The controller 40 was calibrated at the factory to determine constant values specific to the aerosol-generating device that may be used in combination with the summed differences between the pressure measurements during the puff and the moving average pressure to determine the puff volume.

Once the controller 40 determines that the puff has ended, the controller continues to update the moving average pressure with each new pressure measurement. In this way, the moving average pressure acts as a baseline against which each new pressure measurement can be compared to determine whether a larger than expected change in pressure has occurred. By using a moving average pressure as the baseline, the baseline varies with gradual changes in atmospheric or external pressure, such as when a user changes altitude or when the weather changes. This reduces the likelihood of false puff detections being made by the controller 40.

The controller 40 controls the supply of power to the inductor coil 24 based on the determined puff volume and duration. Where a puff volume and duration is larger than expected by the controller, indicating a user has taken a bigger puff on the aerosol-generating device than expected, the controller increases the power supplied to the inductor coil for the subsequent detected puff to increase the aerosol generated during the puff.

FIG. 4 shows a cross-sectional view of an aerosol-generating device 10 according to a second embodiment. The aerosol-generating device 10 of FIG. 4 is similar to the aerosol-generating device 10 described with reference to FIGS. 1 and 2 and like reference numerals are used to designate like parts.

The aerosol-generating device 10 of FIG. 4 differs from the aerosol-generating device 10 of FIG. 1 by the addition of a susceptor element 50. The susceptor element 50 has an elongate shape and extends into the substrate cavity 16 from the closed end 20 of the substrate cavity 16. The susceptor element 50 extends along the central axis 36 of the aerosol-generating device 10 so that the inductor coil 24 extends concentrically around the susceptor element 50.

FIG. 5 shows a cross-sectional view of an aerosol-generating system 100 comprising the aerosol-generating device 10 of FIG. 4 and an aerosol-generating article 102. The aerosol-generating system 100 of FIG. 5 is similar to the aerosol-generating system 100 described with reference to FIG. 3 and like reference numerals are used to designate like parts.

The aerosol-generating system 100 of FIG. 5 differs from aerosol-generating system 100 of FIG. 3 by the absence of a susceptor element in the aerosol-generating article 102. When the aerosol-generating article 102 is inserted into the substrate cavity 16, the susceptor element 50 of the aerosol-generating device 10 is received within the aerosol-forming substrate 104 of the aerosol-generating article 102. FIGS. 4 and 5 show the susceptor element 50 as having a pin- or blade-shaped profile, thereby facilitating penetration of the aerosol-forming substrate 104 by the susceptor element 50 of the aerosol-generating device 10 during insertion of the aerosol-generating article 102 into the substrate cavity 16 of the aerosol-generating device 10. The skilled person will appreciate that the susceptor element 50 of the aerosol-generating device may have a profile other than that shown in FIGS. 4 and 5.

Once the aerosol-generating article 102 has been inserted into the substrate cavity 16, the operation of the aerosol-generating system 100 of FIG. 5 is identical to the operation of the aerosol-generating system 100 described with reference to FIG. 3.

FIG. 6 shows a cross-sectional view of an aerosol-generating device 10 according to another embodiment. The aerosol-generating device 10 of FIG. 6 is similar to the aerosol-generating device 10 described with reference to FIGS. 1 and 2 and like reference numerals are used to designate like parts.

The aerosol-generating device 10 of FIG. 6 differs from the aerosol-generating device 10 of FIG. 1 by the inductor coil 24 being embedded in a portion of the cylindrical wall 22 of the housing 12, and the annular gap 32 being provided in the cylindrical wall 22, between the inductor coil 24 and the outer surface of the cylindrical wall. The annular gap 32 has an annular opening 33 circumscribing the open end 18 of the substrate cavity 16. The annular gap 32 also extends below the closed end 20 of the substrate cavity 16, and continues beneath the closed end of the substrate cavity 20 to an opening 34 at the closed end 20 of the substrate cavity 16. The opening 33, annular gap 32 and opening 34 form an airflow path through which ambient air may be drawn into the substrate cavity 16 at the closed end 20. The opening 33 forms an inlet of the airflow path through which ambient air may be drawn into the aerosol-generating device 10. The aerosol-generating device 10 of FIG. 6 further differs from the aerosol-generating device 10 of FIG. 1 by a flow restriction 35 in the airflow path between the opening 33 and the opening 34, and by the pressure sensor 39 being positioned to detect the pressure at the flow restriction 35. The flow restriction 35 is provided below the closed end 20 of the substrate cavity 16, close to the opening 33 in the closed end 20. In this embodiment, the flow restriction 35 comprises a narrow portion, the narrow portion having a smaller diameter than the portions of the airflow path immediately upstream and downstream of the narrow portion. By positioning the pressure sensor 39 in the narrow portion, the pressure sensor 39 is able to detect the pressure drop in the airflow path caused by the flow restriction when a user puffs on the aerosol-generating device 10.

FIG. 7 shows a cross-sectional view of an aerosol-generating device 10 according to another embodiment. The aerosol-generating device 10 of FIG. 7 is similar to the aerosol-generating device 10 described with reference to FIG. 6 and like reference numerals are used to designate like parts.

The aerosol-generating device 10 of FIG. 7 differs from the aerosol-generating device 10 of FIG. 6 by the pressure sensor 39 being arranged to detect the pressure in the airflow path after the flow restriction 35. The pressure sensor 39 is arranged immediately after the narrow portion 35, downstream of the narrow portion 35. In this embodiment, the narrow portion 35 may be provided by an orifice plate, and where the narrow portion 35 is provided by an orifice plate, the pressure sensor 39 may be arranged in the position of a corner tap.

FIG. 8 shows a cross-sectional view of an aerosol-generating device 10 according to another embodiment. The aerosol-generating device 10 of FIG. 8 is similar to the aerosol-generating device 10 described with reference to FIG. 6 and like reference numerals are used to designate like parts.

The aerosol-generating device 10 of FIG. 8 differs from the aerosol-generating device 10 of FIG. 6 by the pressure sensor 39 being a differential pressure sensor arranged to detect the difference in pressure in the airflow path at the flow restriction 35 and after the flow restriction 35.

In the embodiment of FIG. 8, the controller (not shown) receives differential pressure measurements from pressure sensor 39. The controller 40 is configured to detect a puff and determine a puff volume from these differential pressure measurements.

The controller 40 is configured to compare the differential pressure measurements to a threshold, and detect a puff on the aerosol-generating device 10 when the differential pressure measurements are above the threshold, indicating a pressure drop across the flow restriction 35 corresponding to a puff on the aerosol-generating device 10.

The controller 40 continues to compare the differential pressure measurements to the threshold during the puff, and when the differences falls below the threshold, the controller 40 determines that the puff has ended.

The controller 40 determines the duration of the puff from the time period between when the puff was detected and when the puff ended.

The controller 40 further determines the volume of the puff by summing, over the duration of the puff, the differential pressure measurements.

FIG. 9 shows a cross-sectional view of an aerosol-generating device 10 according to another embodiment. The aerosol-generating device 10 of FIG. 9 is similar to the aerosol-generating device 10 described with reference to FIG. 8 and like reference numerals are used to designate like parts.

The aerosol-generating device 10 of FIG. 9 differs from the aerosol-generating device 10 of FIG. 8 by the pressure sensor 39 being a differential pressure sensor arranged to detect the difference in pressure in the airflow path before the flow restriction 35 and at the flow restriction 35.

FIG. 10 shows a cross-sectional view of an aerosol-generating device 10 according to another embodiment. The aerosol-generating device 10 of FIG. 10 is similar to the aerosol-generating device 10 described with reference to FIG. 8 and like reference numerals are used to designate like parts.

The aerosol-generating device 10 of FIG. 10 differs from the aerosol-generating device 10 of FIG. 8 by the pressure sensor 39 being a differential pressure sensor arranged to detect the difference in pressure in the airflow path before the flow restriction 35 and after the flow restriction 35. In this embodiment, the flow restriction 39 may be provided by an orifice plate, with an orifice diameter smaller than the diameter of the airflow path immediately before and after the orifice plate. Where the flow restriction 35 is provided by an orifice plate, the pressure sensor 39 may be arranged to detect the difference in pressure immediately before and after the orifice, in the position of corner taps.

In each of the embodiments of FIGS. 8, 9 and 10, where the pressure sensor 39 is a differential pressure sensor arranged to sense the difference in pressure between a first point and a second point in the airflow path, the differential pressure sensor may be replaced by two pressure sensors, a first pressure sensor arranged to detect the pressure at the first point in the airflow path and a second pressure sensor arranged to detect the pressure at the second point in the airflow path.

FIG. 11 shows a portion of the airflow path in the aerosol-generating devices 10 of the embodiments of FIGS. 6, 7, 8, 9 and 10. As shown in FIG. 11, in each of these embodiments the flow restriction comprises a narrow portion of the airflow pathway, having a diameter 60. Where the narrow portion is not formed by an orifice plate, and has a longitudinal extent, the pressure may be measured in the narrow portion at a position 61. The airflow path also has a downstream portion immediately after the flow restriction. The downstream portion has a diameter 62. The pressure in the downstream portion may be measured at a position 63. The airflow path also has an upstream portion immediately before the flow restriction. The upstream portion has a diameter 64. The pressure in the upstream portion may be measured at a position 65. In these embodiments, the diameters 64, 62 of the upstream portion and the downstream portion are the same, and are greater than the diameter 60 of the flow restriction.

FIG. 12 shows a cross-sectional view of an aerosol-generating system 100 comprising the aerosol-generating device 10 of FIG. 8 and an aerosol-generating article 102, which is the same as the aerosol-generating article 102 depicted in FIG. 3 and like reference numerals are used to designate like parts.

Airflow through the aerosol-generating system 100 of FIG. 12 during use is illustrated by the dashed line 116 in FIG. 12. When a user draws on the mouthpiece 110 of the aerosol-generating article 102, a negative pressure is generated in the substrate cavity 16. The negative pressure draws air into the substrate cavity 16 via the airflow path through the aerosol-generating device. The air entering the substrate cavity 16 flows into the airflow path through the annular opening 33, through the annular gap 32, beneath the closed end 20 of the substrate cavity 16, up through the flow restriction 35 and out into the substrate cavity 16 through the opening 34 at the closed end 20 of the substrate cavity 16. When the airflow reaches the closed end 20 of the substrate cavity 16, the air enters the aerosol-generating article 102 through the aerosol-forming substrate 104. As the airflow passes through the aerosol-forming substrate 104, aerosol generated by heating of the aerosol-forming substrate 104 is entrained in the airflow. The aerosol then flows along the length of the aerosol-generating article 102 and through the mouthpiece 110 to the user.

FIG. 13 shows the aerosol-generating system 100 of FIG. 12, including a display 70 and a user interface, in the form of a button 71. The button 71 is used by a user to activate and deactivate the aerosol-generating device 10. The display 70 displays usage information from the controller 40. The usage information comprises an aerosol-forming substrate depletion level, indicating the depletion level of the aerosol-forming substrate in the form of a pie chart, and a maximum number of puffs remaining, indicating how many puffs a user can take before the aerosol-forming substrate is consumed. The usage information is determined by the controller 40 from the pressure measurement information received from the pressure sensor 39.

FIG. 14 shows the aerosol-generating system 100 of FIG. 12 in communication with an external device 200 and the cloud 202. The aerosol-generating device 10 comprises a transceiver (not shown) in communication with the controller 40. The controller 40 sends pressure measurement information and determined usage information to the server 40 and the cloud 202 via the transceiver. The server 200 and the cloud 202 can store and process the pressure measurement information and determined usage information to notify a user of usage patterns via the user's mobile phone or other device (not shown).

It will be appreciated that in other embodiments, the server 200 may be configured to determine the usage information, such as the puff volume and puff duration, from the pressure measurement information, rather than the controller 40 of the aerosol-generating device performing these determinations. The server 200 may then send the determined usage information to the aerosol-generating device 10, for the aerosol-generating device 10 to display to a user and control the supply of power to the inductor coil 24.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent (10%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device, comprising:
a substrate cavity configured to receive an aerosol-forming substrate;
an airflow path extending between an inlet and the substrate cavity;
a flow restriction located in the airflow path;
a pressure detection apparatus configured to detect a pressure in the airflow path at or after the flow restriction, between the flow restriction and the substrate cavity, the pressure detection apparatus comprising a pressure sensor configured to detect the pressure in the airflow path either at or after the flow restriction; and
a controller configured to receive pressure measurement information from the pressure detection apparatus and to determine a puff volume based on pressure measurement information received from the pressure detection apparatus.

17. The aerosol-generating device according to claim 16, wherein the pressure detection apparatus is further configured to detect the pressure in the airflow path either:
before the flow restriction, between the inlet and the flow restriction, and at or after the flow restriction, between the flow restriction and the substrate cavity, or
at the flow restriction and after the flow restriction, between the flow restriction and the substrate cavity.

18. The aerosol-generating device according to claim 17, wherein the pressure detection apparatus further comprises one of:
a first pressure sensor configured to detect the pressure before the flow restriction, and a second pressure sensor configured to detect the pressure at or after the flow restriction, or
a first pressure sensor configured to detect the pressure at the flow restriction, and a second pressure sensor configured to detect the pressure after the flow restriction, or
a differential pressure sensor configured to detect the difference between the pressure before the flow restriction and the pressure at or after the flow restriction, or
a differential pressure sensor configured to detect the difference between the pressure at the flow restriction and the pressure after the flow restriction.

19. The aerosol-generating device according to claim 17, wherein the controller is further configured to determine the puff volume by:
determining an average pressure from a plurality of the pressure measurements,
determining a change in a subsequent pressure measurement from the determined average pressure, the change being indicative of a pressure drop corresponding to a puff on the aerosol-generating device by a user,
summing, over a duration of the puff, the determined differences between the pressure measurements during a determined puff and the determined average pressure, and
determining a volume of the puff based on the summed determined differences over the determined puff duration.

20. The aerosol-generating device according to claim 16,
further comprising an aerosol generator configured to generate an aerosol from an aerosol-forming substrate received in the substrate cavity,
wherein the controller is further configured to control a supply of power to the aerosol generator based on the determined puff volume.

21. The aerosol-generating device according to claim 16, wherein the controller is configured to determine, based on at least one of the determined puff volume and puff duration, at least one of:
a maximum number of puffs remaining, which corresponds to a maximum number of puffs a user is able to take on the aerosol-generating device before the aerosol-generating substrate received in the substrate cavity is depleted, and
a maximum duration of time remaining for aerosol generation, which corresponds to a maximum duration of time power is able to be supplied to the aerosol generator before the aerosol-generating substrate received in the substrate cavity is depleted.

22. The aerosol-generating device according to claim 21,
further comprising an aerosol-generator,
wherein the controller is further configured to prevent a supply of power to the aerosol generator once at least one of:
the determined maximum number of puffs remaining has been reached, and
the determined maximum duration of time remaining for aerosol generation has been reached.

23. The aerosol-generating device according to claim 16, wherein the controller is further configured to determine usage information based on at least one of the determined puff volume and puff duration, the usage information being information regarding a user's puffing habits on the aerosol-generating device based on the pressure measurement information from the pressure detection apparatus.

24. The aerosol-generating device according to claim 16,
further comprising a transmitter,
wherein the aerosol-generating device is configured to send a pressure measurement signal from the transmitter to an external device, the pressure measurement signal including pressure measurement information detected by the pressure detection apparatus.

25. The aerosol-generating device according to claim 24,
further comprising a receiver,
wherein the receiver is configured to receive a usage signal from an external device, the usage signal comprising usage information, the usage information being information regarding a user's puffing habits on the aerosol-generating device based on the pressure measurement information sent to the external device.

26. The aerosol-generating device according to claim 23,
further comprising an indicator coupled to the controller,
wherein the controller is further configured to indicate to a user usage information on the indicator.

27. The aerosol-generating device according to claim 26, wherein the indicator comprises at least one of a visual indicator, an audible indicator, and a tactile indicator.

28. The aerosol-generating device according to claim 23, wherein the usage information comprises at least one of:
a maximum number of puffs remaining, which corresponds to a maximum number of puffs a user a user is able take on the aerosol-generating device before the aerosol-generating substrate received in the substrate cavity is depleted,
a maximum duration of time remaining for aerosol generation, which corresponds to a maximum duration of time power is able to be supplied to the aerosol generator before the aerosol-generating substrate received in the substrate cavity is depleted,
a puff count, wherein the puff count is the number of puffs the user has taken on the aerosol-generating device for an aerosol-forming substrate received in the substrate cavity, and
a depletion level of the aerosol-forming substrate, the depletion level corresponding to a fraction or percentage of the aerosol-forming substrate that has not been consumed or depleted during use.

29. The aerosol-generating device according to claim 28,
further comprising an indicator coupled to the controller,
wherein the controller is further configured to indicate to a user usage information on the indicator, and
wherein the indicator comprises at least one of a visual indicator, an audible indicator, and a tactile indicator.

30. A method of operating the aerosol-generating device according to claim 16, the method comprising:
measuring the pressure at or after a flow restriction of an airflow path of the aerosol-generating device;
determining a puff volume based on the measured pressure; and
controlling a supply of power to an aerosol generator of the aerosol-generating device based on the determined puff volume.

31. The method according to claim 30, further comprising:
determining an average pressure from a plurality of the pressure measurements;
determining a difference between a subsequent pressure measurement and the average pressure;
detecting a puff on the aerosol-generating device by determining whether the difference between the subsequent pressure measurement and the average pressure is indicative of a pressure drop corresponding to a puff on the aerosol-generating device by a user;
when a puff is detected, determining the difference between subsequent pressure measurements during the puff and the average pressure;
determining a duration of the puff from the differences between the subsequent pressure measurements and the average pressure;
summing, over the duration of the puff, the differences between the pressure measurements during the puff and the average pressure;
determining a volume of the puff based on the summed differences between the pressure measurements during the puff and the average pressure over the determined puff duration; and
controlling a supply of power to an aerosol generator of the aerosol-generating device based on the determined puff volume.

32. A method of operating an aerosol-generating device, the method comprising:
measuring a pressure before a flow restriction of an airflow path of the aerosol-generating device during a puff on the aerosol-generating device;
measuring a pressure at or after the flow restriction of the airflow path during the puff on the aerosol-generating device;
determining a difference between pressure measurements before the flow restriction and pressure measurements at or after the flow restriction during the puff;
summing, over a duration of the puff, the differences between the pressure measurements before the flow restriction and the pressure measurements at or after the flow restriction;
determining a volume of the puff based on the summed differences between the pressure measurements before the flow restriction and the pressure measurements at or after the flow restriction over the puff duration; and
controlling a supply of power to an aerosol generator of the aerosol-generating device based on the determined puff volume.

33. A method of operating an aerosol-generating device, the method comprising:
measuring a pressure at the flow restriction during a puff on the aerosol-generating device;
measuring a pressure after the flow restriction during a puff on the aerosol-generating device;
determining a difference between pressure measurements at the flow restriction and pressure measurements after the flow restriction during the puff;
summing, over a duration of the puff, the differences between the pressure measurements at the flow restriction and the pressure measurements after the flow restriction;
determining a volume of the puff based on the summed differences between the pressure measurements at the flow restriction and the pressure measurements after the flow restriction over the puff duration; and
controlling a supply of power to an aerosol generator of the aerosol-generating device based on the determined puff volume.
